(19) United States
(12) Patent Application Publication
(10) Pub. No.: US 2012/0239558 A1
(43) Pub. Date: Sep. 20, 2012

(54) METHOD AND SYSTEMS FOR EFFICIENTLY PROCESSING LARGE VOLUMES OF COMPLEX SMALL VALUE FINANCIAL TRANSACTIONS

(75) Inventor: Jian Zhang, Morgan Hill, CA (US)

(73) Assignee: GridX, Inc., Sunnyvale, CA (US)

(21) Appl. No.: 13/422,943

(22) Filed: Mar. 16, 2012

Related U.S. Application Data
(60) Provisional application No. 61/453,427, filed on Mar. 16, 2011.

(51) Int. Cl. G06Q 40/00

(52) U.S. Cl. 705/39; 705/35

(57) ABSTRACT

The present invention provides a means for a system to model the financial terms of a contract. The system receives a contract and the details of a transaction governed by the contract as inputs and outputs a processed transaction. The system models the financial terms of the contract as a function of one or more parameters. Each of the parameters are further reduced to one or more rules, where each rule represents the terms of the contract as a set of conditions and associated actions. The actions are performed by the system when a corresponding condition is satisfied. The system determines the values of the various parameters by analyzing the outcome of the condition-action sets in relation to the given input transaction.

### PRIORITY CLAIM

This application claims priority to U.S. Provisional Patent Application No. 61/453,427, entitled “Method and system for efficiently processing large volumes of complex small value financial transactions”, which was filed on Mar. 16, 2011, the contents of which are expressly incorporated by reference herein.

### FIELD OF THE DISCLOSED TECHNOLOGY

The technology disclosed herein relates to financial processing methods and systems and in particular to systems for processing large numbers of complex small value transactions governed by a contract between a buyer and a seller.

### BACKGROUND

The technology disclosed herein is motivated by a new class of financial transactions emerged in online digital marketplaces and networks in recent years that are resulted from the overlay of broadband networks over traditional distribution models. These types of financial transactions have the following characteristics: (1) small value, typically in the range of a few pennies to less than a dollar; (2) bi-directional in that buyers can be sellers and vice versa, (3) complex, governed by a set of complex forward contracts between buyers and sellers and (4) large transaction volume, typically in the range of billions per day.

The adoption of broadband networks in such distribution models has substantially reduced the transaction cost of buying and selling goods and services. Buyers (e.g., consumers) now have the option to consume in “bite size” amounts and sellers can profitably sell their goods and services in “bite size” amounts. The result is a significant reduction in the value of individual transactions but an increase in the overall volume of transactions.

This class of online marketplaces also gives rise to greater complexity in business models and contractual relationships between buyers and sellers. First, a participant to the marketplaces can either be a buyer, a seller or both. Second, new business models such as sponsorships, affiliates, aggregation of goods and services involves multiple parties in single transactions. Lastly, contractual relationships between buyers and sellers are complex and constantly evolving.

The prior art models these contractual relationships as customized software, where, for example, each contractual term is programmed as subroutine, which are then invoked by the modeling software when the contractual terms are to be modeled. While such implementations work great for simple, static, unidirectional contractual relationships, they are inadequate to support the current, complex online marketplace. For one, in any given transaction, there could be multiple parties with each transacting party governed by their own, independent contractual relationship. Such a scenario would require the programming of each of these distinct contracts and their associated subroutines to support the transactions in the online market place. Further, in the event any of the parties change the terms of their contractual relationship, not only does it require reprogramming the subroutines governing the changed terms of the contract, the entire software utilizing the reprogrammed subroutines need to be recompiled.

The recompiling is necessary to incorporate the latest subroutines into the modeling software. Such recompiling of the software source code that supports the current, complex world of online market place is anything but trivial. For one, when the software is being recompiled, the software needs to be stopped and rebooted to reflect the changes to the contractual terms. Also, all transactions processed by the software needs to be stopped and sometimes rolled back, in the event the software was stopped when part of a transaction had already been processed. Finally, in a constantly evolving online market place, the software might need to be constantly reprogrammed to reflect the evolving contractual relationships, making utilization of a preprogrammed software package to model contractual relationships practically infeasible. The disclosed technology represents a general purpose financial application that addresses the various shortcomings of the prior arts while filling a void in the commercially available financial services in the market (see FIG. 1).

These financial services can generally be categorized by, on the one hand, the pricing relationship between buyers and sellers the financial services must support, and by the business model on the other. Payment solutions and ERPs are designed to support buying and selling based on spot pricing: the buyer and seller agree on the price of the transaction at the time of transaction, and the payment solution processes the transaction. Consumer payment solutions, such as credit and debit cards, enable a merchant to sell goods and services to consumers (one-to-many). Solutions such as ACH and ERP enable business-to-business payments, while micro-payment solutions such as Pay Pal enable peer-to-peer consumer payments. Billing systems allow a service provider to evaluate the value of transactions based on pre-agreed contract between the service provider and their customers and to collect payments from customers (one-to-many). However, in contrast to consumer payment solutions, billing systems support forward contracts between services providers and customers. The disclosed technology fills the void that exists at the intersection of peer-to-peer payments and billing systems. It enables any one individual and business to sell goods and services to another based on pre-arranged agreements, before the transactions, that specify how would-be transactions are evaluated under various circumstances in which transactions take place.

Two examples of such online marketplaces in which buying and selling are based on complex financial contacts and transactions at reduced value occur in the media and energy markets. In the utility market, a new generation of smart grids has resulted from the overlay of broadband networks over traditional electricity grids (see FIG. 2). The buyers and sellers in these smart grids are governed by more complex contractual relationships, the transaction value is much smaller, and transaction volume is greater. In the past, utilities are the only sellers of energy and consumers the only buyers, the contractual relationships are much simpler (often static pricing) and the household power meters were only read once a month to calculate the energy used in that month. Utility billing systems are used to calculate the receivables from customers for the month of energy consumption. New smart grids enable utilities to read power meters at much more frequent intervals, due to substantially reduced the cost of meter reading, and sell electricity in much smaller increments such as every hour or every 15 minutes—often at different dynamic pricing tariffs. In additional to selling energy to its customers, the utility can buy energy from its customers who generated energy in-house through rooftop solar panels. While the utility selling is based on retail tariff, the buying is based on a tariff structure known as Feed-in-Tariff. A separate meter is dedicated to measure the energy bought by the utility and read by the utility at different periodic intervals and different pricing points to calculate the payment accrued to the customers.

In a more complex business model, the customer can either use the energy generated in-house for self consumption and hence buy less from the utility or sell the all of the amount generated in-house to the utility at the Feed-in-Tariff and buy more from the utility at the retail tariff.

A variation of the above model involves the customer sells non-energy (or energy-related) goods and services. In addition to selling energy generated in-house to the utility, the customer sells certain rights, based on a contractual arrangement called demand response contract, to the utility so that the utility can reduce the customer energy consumption involuntarily at time of the constrained supply. Other energy-related goods and services include Ancillary Services, Renewable Energy Credit and Green House Gas.

An even more complex model involves a customer selling energy to another. In such a model, Customer A generating energy in-house can sell the energy to another Customer B, based on a separate contract between the two customers, and thus sells less to the utility but allows customer B to buy less from the same utility. In such an application, a separate meter is dedicated to measure the amount of energy sold by the customer to his neighbor. The utility can read the meter at certain periodic intervals and calculate the amount Customer B owes on behalf of Customer A.

Another example is in the media market (see FIG. 3). Increase in bandwidth for a new generation of networks has made it not only feasible to deliver digital goods—such as content, applications, and advertising—through online marketplaces, but also at reduced transaction cost. Online and mobile consumers demand unbundling of traditional content, media, and entertainment and the reduction in transaction cost due to the always on networks make it possible. Rather than such bundles as CDs or albums, they buy single tracks of music; rather than full-track music, they demand ringtones or a segment of music; rather than pre-programmed broadcast radio, they listen to podcasts; rather than linear TV programming, they choose episodes or video clips. Such unbundling of content, applications, and media significantly decreases the value of individual transactions and increases the volume of transactions.

The value exchange between producers and consumers of digital goods online is often bi-directional. Consumers can be producers and vice versa. Indeed, a party involved in a transaction can be both a consumer and a producer of digital goods at the same time.

This class of online marketplaces is typically mediated by one or more intermediaries, working together in coordination to deliver digital goods to consumers. The relationships among participants are often defined by complex, pre-negotiated financial agreements. The value exchange with consumers and the value distribution among participating producers and intermediaries are typically pre-agreed before the transactions and therefore must be evaluated dynamically based on the circumstances involved in the transactions. As multiple participants and multiple interconnected marketplaces work in concert to deliver digital goods, the values of the transactions must be distributed among those who contribute.

Such financial transaction processing technology must be high throughput with a corresponding high reliability and integrity. In addition, the technology must be highly efficient so small value transactions can be processed economically and profitably.

The present technology discloses a method and system to clear financial transactions related to buying and selling goods and services between two or among multiple parties, based on the pre-agreed contractual arrangements between and among buyers and sellers, over an arbitrary complex trading relationships. Due to that such contractual arrangements between buyers and sellers are contingent upon the circumstances under which the transactions take place, the value of the transactions is usually not obviously known and only becomes clear after the transactions and upon applying with the financial terms of the contracts to the transaction records. The duration of these contractual arrangements usually span substantial periods of time during which the buyers and sellers can carry out large number of repeated transactions. The transacting parties involved can be between a buyer and a seller or among multiple buyers and sellers. The transactions can be bi-directional in which a buyer can be a seller and vice versa. Lastly, the topology of the trading relationships, as defined by the contractual pre-arrangements between and among transacting parties, can be arbitrarily complex and indeed often cascaded.

The beneficiary of the disclosed technology ranges from Investor Owned Utilities (IOUs) to municipal utilities; from Plug-in Electric Vehicle (PEV) charging networks to wholesale energy markets; from energy service providers to demand response services aggregators, from traditional media companies such as music labels, movie studios, TV networks, newspapers, and magazine and book publishers to online application stores; and from content syndication networks to advertising networks.

### SUMMARY OF THE INVENTION

The present invention provides a general means for modeling the terms of a contract as a function of one or more parameters, where each of the one or more parameters is defined by one or more rules. A rule engine then evaluates and executes these rules, which are, for example, expressed as if-then statements. Based on the rules, the rule engine internally determines the order or the dependencies of the rules. Next, the rule engine determines which rule from the rule set to evaluate based on the input required for the rule as well as the results obtained from the evaluation of previous rules. Thus, the underlying idea of modeling the terms of a contract as rules, which are interpreted by a rule engine, is to separate the modeling of a contract from its implementation logic. This separation, in-turn, enables modeling changes to contractual terms as simple addition or deletion of rules from the rule set without requiring any change to the source code of the implementation logic.

The rule engine can, thus, be viewed as a sophisticated interpreter of if-then statements. The rules are expressed as if-then statements. The rule, as described, is composed of two parts, a condition and an action: When the condition is met, the action is executed. The if portion contains conditions (for e.g., amount spent >=$100), and the then portion contains actions (for e.g., offer discount 5%). The rule engine receives, as inputs, a collection of rules called the rule execution set and input data (for e.g., the actual amount of money spent). The rule engine interprets the relationship of the rules, applies the input data to the interpreted rules and determines the final output, (for e.g., the final discount to offer a customer). Thus, the present invention provides a general means for modeling the terms of a contract without requiring any changes to the source code of the implementation logic.

### BRIEF DESCRIPTION OF DRAWINGS

FIG. 1 is the portfolio of commercially available financial services, the proposed financial clearing technology fills a void in which the relationships between a buyer and a seller are based on complex forward contracts, and a buyer can be a seller, and vice versa. Furthermore, the transactions involved are typically a very large volume of small-value transactions. FIG. 1 illustrates the new financial services the disclosed technology is designed to enable.

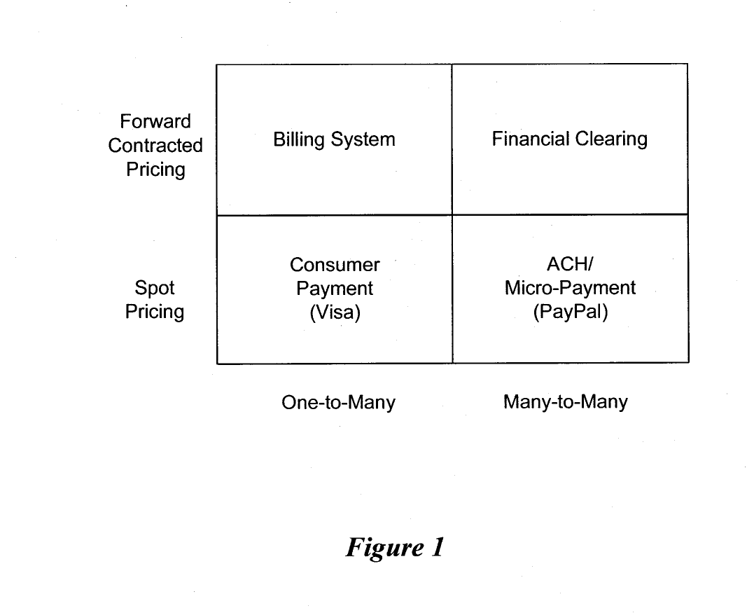

FIG. 2 illustrates the topology of a simple trading community involved in Smart Grid application. The broadband overlay has turned an otherwise one-way electricity distribution grid into a marketplace in which consumers not only can buy electricity but also sell it—generated from PV rooftops, through rights to shed load if they participate in a Demand Response program, and via ancillary or storage services or Renewable Energy Credit—all with complex, dynamic tariffs or contracts. The arrows indicate the payment directions.

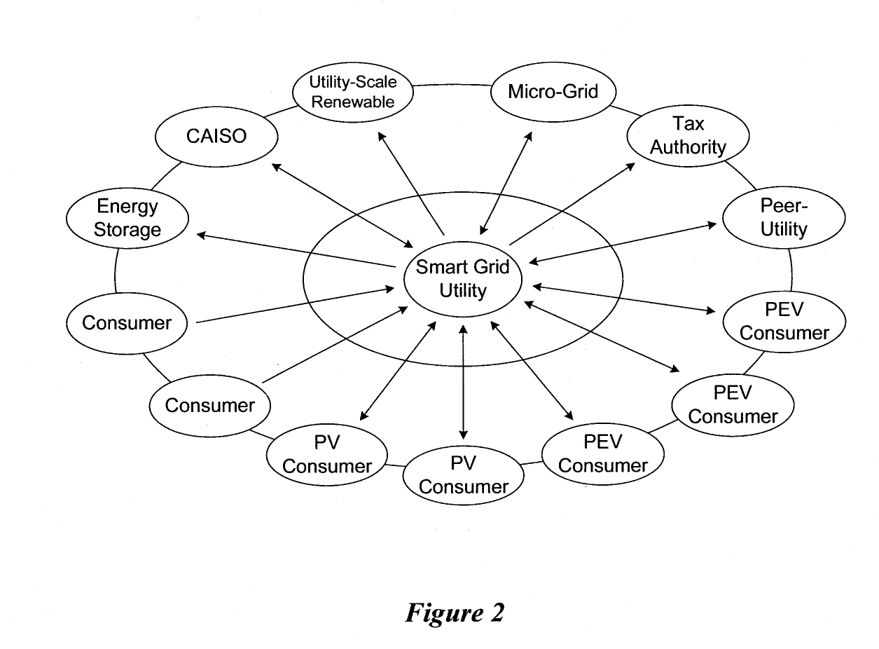

FIG. 3 illustrates the topology of a simple trading community involved in digital media application. Digital distribution of media over the broadband network has introduced online music stores into a marketplace where content can be purchased from content providers for resale to consumers, where consumers can produce content and advertising impressions, and where content providers can also buy advertising inventory. The arrows indicate the direction of payments.

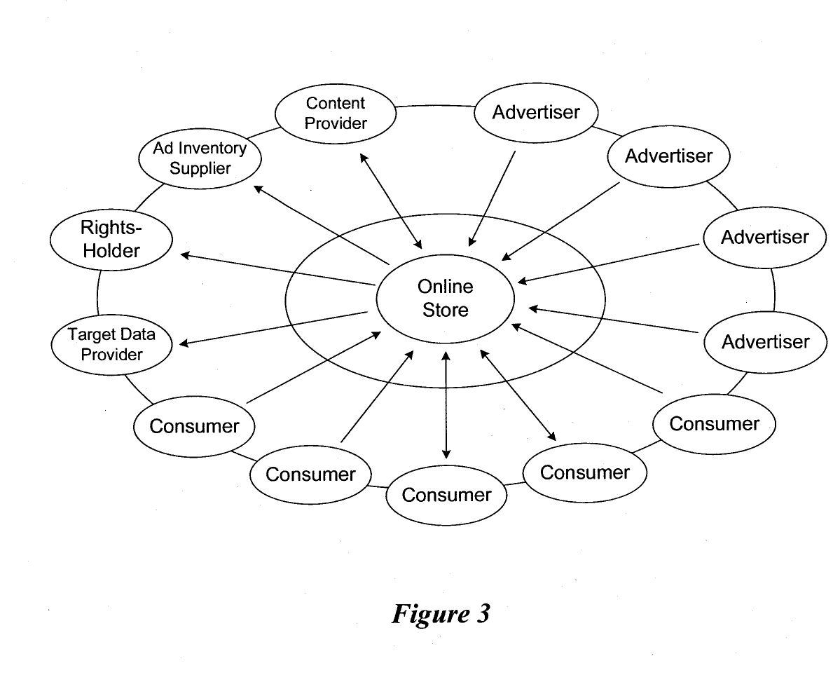

FIG. 4 illustrates one representative environment, smart grid, whereby a financial processing system of the disclosed technology can be utilized.

FIG. 5 illustrates another representative environment, digital media, whereby a financial processing system of the disclosed technology can be utilized.

FIG. 6 illustrates a generalized method to model the financial terms of a contract, with which the contracted payment from a buyer to a seller can be represented by an arithmetic function of one or multiple decision trees including contracted effective amount of transactions, effective price and effective adjusted scaling factor.

FIG. 7 illustrates an example of electricity retail tariff, a contact between a buyer (customer) and a seller (utility), as represented by a decision tree. In this case, the price of the electricity varies depending on the season of the year, time of use and voltage level the buyer customer uses.

FIG. 8 illustrates an example of electricity Feed-in-Tariff, a contract between a buyer (utility) and a seller (customer) for energy generated by the customer in-house, as represented in a decision tree. The price of electricity with which the utility buyer buys from its customer seller varies depending on the season of the year, time of delivery, contract start year and the term of the contract.

FIG. 9 illustrates an example of demand response contract as represented by a decision tree, a contract between a buyer (utility) and a seller (customer) for selling his rights to his energy consumption. The contracted payment by the utility to the customer for such rights is the product of the committed load reduction and committed rate. The committed rate itself is a product of four decision trees: Committed Load Base Price and three modifiers. The committed load base price varies with notification time of the demand response event. Modifier #1 varies with number of demand response events call during the month, modifier #2 varies with the frequency of the demand response event and modifier #3 varies with the time in which the demand response event is called.

FIG. 10 illustrates an example of a part of music royalty contract between a buyer (music label) and a seller (artist) for selling rights to music. The overall royalty payable by the buyer to the seller is the product of three decision trees: effective royalty rate, effective price, and effective unit. Effective royalty rate itself is an arithmetic function of Basic US Rate, escalation factor, channel reduction and territory reduction, each being a decision tree by itself. This figure shows two of the decision trees: effective price and effective unit.

FIG. 11 illustrates decision trees that represent the base royalty rates, basic US rate, and escalation factor for the music royalty example in FIG. 10.

FIG. 12 illustrates decision trees that represent the channel reduction and territory reduction for the music royalty example in FIG. 10.

FIG. 13 illustrates an example of music royalty payable by an ad-supported licensee to a music label, which is determined based on the greater of two decision trees. The first represents the minimum per play licensing fees while the second represents the revenue share calculation of a portion of the advertising revenue.

FIG. 14 illustrates the integration between the contract rule engine and a processing node, in which the processing node queries the rule engine with the identification number of a contract and the related input parameters and is updated with the financial terms of the contract. The terms are used to calculate the value of the transactions. A rule file is used to update the contacts in the rule engine.

FIG. 15 illustrates examples of bi-party and multi-party transactions that the disclosed technology is designed to clear. The multi-party examples include two sub-examples, one representing the multiple suppliers in a cascaded supply chain while the other representing the multiple suppliers in a parallel supply chain.

FIG. 16 is a flow diagram that represents the bi-party financial clearing process, in which the disclosed technology first looks up the correct contract by searching with buyer ID, seller ID and event type, then obtaining the contractual terms by querying the contract rule-engine and finally calculating the transaction value so that the appropriate value can be debit from the buyer's accounts and credited to the seller's accounts.

FIG. 17 is a flow diagram that represents the multi-party financial clearing process. In processing such multi-party transactions, the disclosed technology decomposes a multi-party transaction into comprising related bi-party transactions.

FIG. 18 illustrates an atomic job's construction, in which the buyer and seller identifications, their original account balance before transactions, original transaction records, and other relevant information are packaged into a single package. The transaction processing results, in the form of changes to the account balances (or alternatively the new balance amount), can be temporarily stored until the results can be updated with the storage file. Such atomic computing job construction is a self contained unit and can be dispatched to a remote processing node. The package contains all the information needed to process a transaction and provisions to temporarily store the intermediate and final results of the processing for auditing purposes and is designed to increase the transaction processing throughput.

FIG. 19 illustrates an embodiment of a distributed version of a system used for file-based transaction processing. With the distributed system, a computer packages the input transactions into atomic computing jobs by combining information from the master storage file and dispatches them to processing nodes using a distributed file system. The processing nodes apply the transaction processing rules to the transactions, determine the financial positions in all relevant account balances and store the account balance debit and credit increments in the atomic jobs. The second computer collects the results of the processing from the atomic computing jobs and updated the storage file. The first and the second computers can be one and the same. The disclosed technology features a check-pointing scheme to improve the reliability of transaction processing. Before an atomic job is dispatched to processing nodes, a duplicate is made for check-pointing purpose. Each processing node processes the transactions independently, based on the information contained in the atomic job. If the transaction is processed successfully, then the buyer and seller financial positions are updated in the atomic job. If the transaction is not processed successfully, the processing task is restarted by fetching the previously check-pointed job and the transactions are re-processed. Such job re-starting and transaction re-processing scheme ensure that all transactions are processed successfully and reliably.

FIG. 20 is a pictorial illustration of transaction sorting and re-ordering in which transactions are sorted and re-ordered according to the transaction attributes such as buyer and seller identifications, contract identification, time stamps and others. Such sorting and re-ordering aggregate like transactions together so that transaction rules can be applied to them altogether to further improve the transaction processing efficiency and at the same time re-establish the time sequence of the transactions so that time and order sensitive transaction processing rules can be applied correctly.

FIG. 21 illustrates an example pre-processing flow chart in which the data from retail and wholesale meters is imported and normalized into a common data format, validated against reference data stored in a file or distributed file system, and corrected automatically based on the pre-processing rules if the data is missing or erred. If the data cannot be corrected automatically, the erred meter data is suspended in a suspense file or distributed file system and a separate manual editing process is used to correct for the errors. The correct meter data is then checked for and eliminated with duplicates, checked for unusually large or small value, and enriched with additional related information for further processing. Finally, the like meter data is aggregated into transaction records on which the contractual terms are applied (see FIG. 19).

FIG. 22 illustrates the use of a distributed file system and a cluster of computer to process the meter data in a large scale and high throughput. In one embodiment, one of the nodes partitions and distributes the meter data, through the distributed file system, to one or more processing nodes where the processes such as those described in FIG. 21 are used to process the meter data. The processed data is then collected and aggregated based on certain common criteria into output transaction records by one or more nodes. The pre-processing rules are configured in a rule engine and distributed by integrating a copy of the rule engine with a processing node.

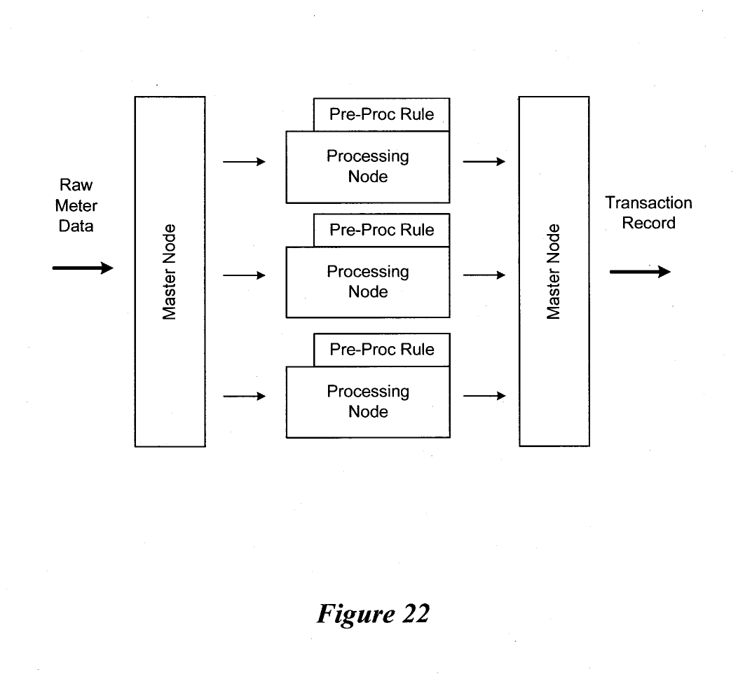

FIG. 23 illustrates the architecture of the disclosed technology, which contains three major components: Marketplace Management System, the master storage file and a distributed execution engine. Marketplace Management System is a web-based application that is used to manage the entity participating in the marketplace and financial terms of contracts between and among the entities participating in buying and selling transactions. The configured data models are stored in a storage file, a set of files or a database. The contract and balance information contained in the storage file are used to process input transactions correctly. The execution engine consists of computers that validates transactions, cleanse the errors and recondition the event data records into transactions, that package the transactions into atomic computing jobs, dispatch them to processing nodes for parallel processing and collect them and update the processing results into the storage file.

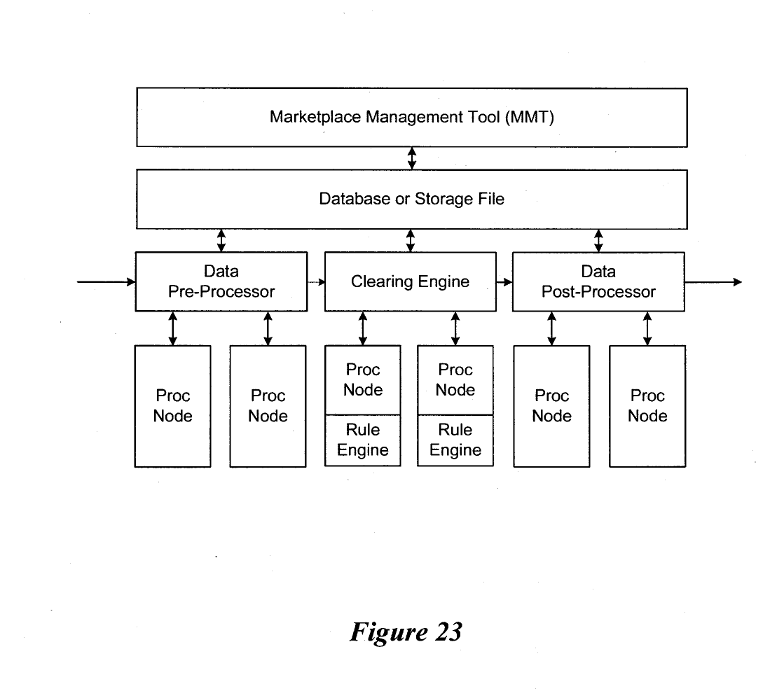

FIG. 24 illustrates the disclosed method of using a decision tree to model a contract template, which can be combined with a set of rate parameters to model the contracts of a common structure and yet different rate parameters.

FIG. 25 illustrates the application of transaction clearing technology to the energy market.

FIG. 26 illustrates the application of transaction clearing technology to the music licensing market.

FIG. 27 is a block diagram of a processing system that can be used to implement a financial computing system implementing certain techniques described herein.

FIG. 28 illustrates a financial computing system used to model the terms of a contracts.

### DETAILED DESCRIPTION OF THE TECHNOLOGY

Various aspects of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description. Although the diagrams depict components as functionally separate, such depiction is merely for illustrative purposes. It will be apparent to those skilled in the art that the components portrayed in this figure may be arbitrarily combined or divided into separate components.

The terminology used in the description presented below is intended to be interpreted in its broadest reasonable manner, even though it is being used in conjunction with a detailed description of certain specific examples of the invention. Certain terms may even be emphasized below: however, any terminology intended to be interpreted in any restricted manner will be overtly and specifically defined as such in this Detailed Description section.

References in this specification to “an embodiment,” “one embodiment,” or the like mean that the particular feature, structure, or characteristic being described is included in at least one embodiment of the present invention. Occurrences of such phrases in this specification do not necessarily all refer to the same embodiment.

The disclosed technology contemplates a variety of improved methods and systems for clearing a new class of financial transactions by modeling terms of the contract between a buyer and a seller using a generalized method and by applying the contract to process the transactions with an efficient high throughput low transaction cost system. The class of transactions targeted is characterized above. The generalized contract modeling technique is based an arithmetic combination of rule based decision trees. The technique improves efficiency and throughput through the use of distributed file system. The technology can be used to model any complex bi-lateral contracts between a buyer and a seller or multi-lateral contracts among multiple buyers and sellers and increases the throughput and lowers the cost for the transaction processing. In one embodiment that uses a distributed file system and multiple processing computers, the technique can further increase the throughput by distributing the processing to a large number of computers working in parallel.

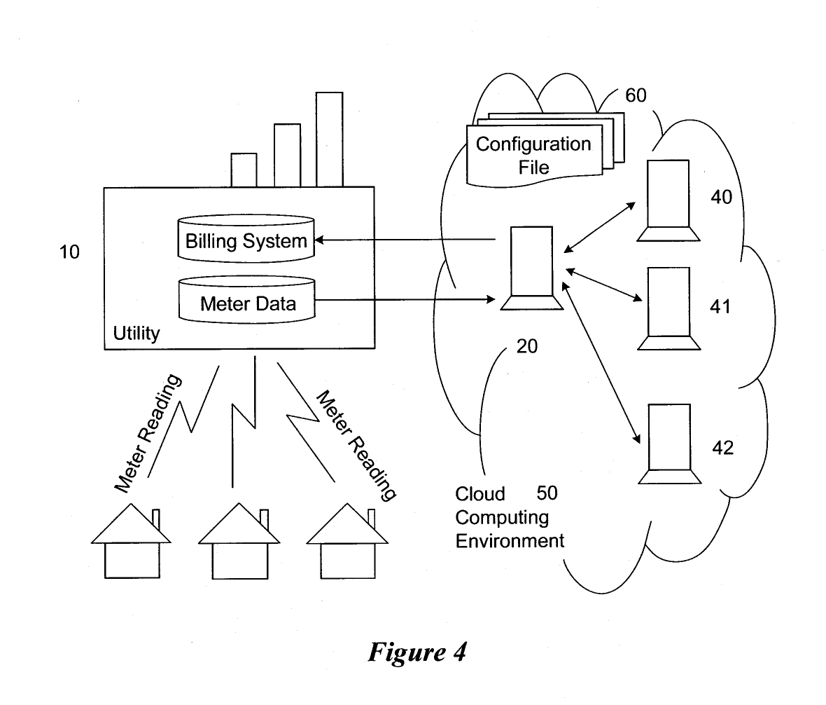

FIG. 4 illustrates a representative smart grid marketplace in which the disclosed financial processing technology can be used. Although the disclosed technology is described with respect to processing transactions related to buying and selling energy and non-energy in a energy grid, those skilled in the art will recognize that the disclosed technology can be used in other fields such as patented intellectual property rights, enterprise software and cloud-computing, etc.

In the exemplary embodiment disclosed in FIG. 4, a utility 10 provides energy to a number of residential customers 12-14. Using a smart grid, the utility 10 can read the power meters at each residence or business at periodic intervals. Such intervals may be once a week, once a day, several times a day, several times an hour depending on the dynamic tariff structure for energy charged by the utility. For example, the utility may charge different rates for energy consumed during peak hours, between 11 am to 6 pm., on weekends etc. To be able to charge the customer correctly, the utility reads the power meter of each residence at periodic intervals to determine how much power is consumed during each period prior to a meter reading. The result is a large number of small value transactions, at different pricing points, that must be processed to produce a final utility bill for the customer.

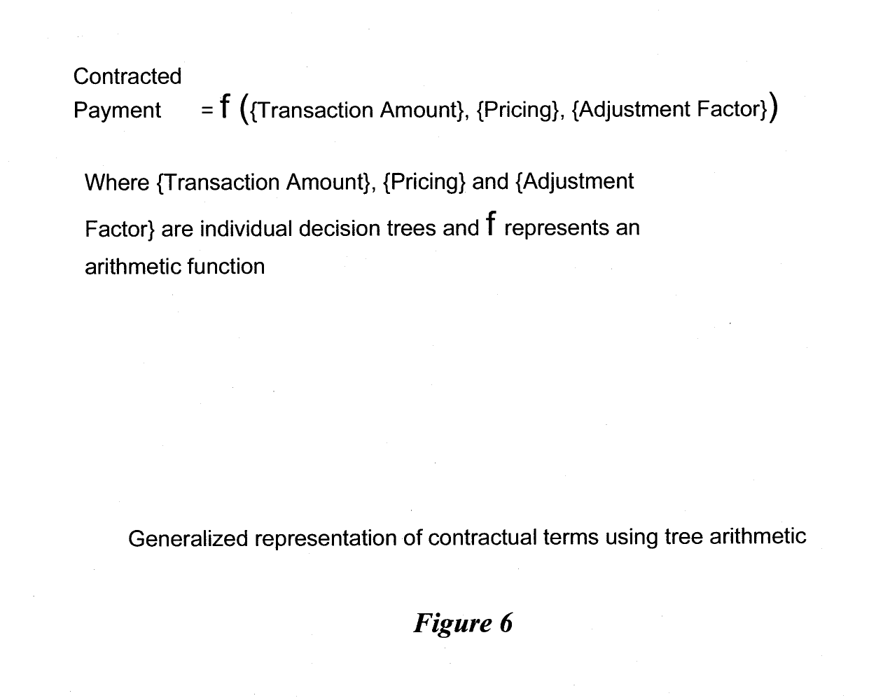

In the exemplary embodiment disclosed in FIG. 6, a digital goods marketplace 11 such as an ad network, content syndication network and rights marketplace, buys content, the associated rights, it to its customers. Alternatively, the marketplace operator can buy advertising inventory from suppliers and sell it to advertisers. In both of these cases, three parties (rights-holder-marketplace-customer or inventory supplier-marketplace-advertiser) are involved in three-party transactions based on revenue sharing agreements (the payments accrued to the rights-holder and advertising inventory supplier depend on that revenue generated by the marketplace). The transaction records, in the forms of ad server logs and content delivery server logs, are collected in a central depository.

A variation of the above use scenario is that the disclosed technology can be used by a third party financial clearinghouse, rather than the utility, to calculate payment amount one accrued to another among the utility and its customers based on respective bi-lateral or multi-lateral contracts, and the corresponding meter readings.

### Modeling Financial Terms of Contracts

A contractual agreement between a buyer and a seller of goods and services in general involves financial terms by which a buyer pays a seller. These financial terms represent the contractual obligation the buyer has to the seller. At times these financial contractual terms can be very complex since the buyer and seller do not know the value of transactions ahead of time and therefore agree to how to value the transactions depending on a large number of contingent circumstances. The contract can be in the forms of a licensing agreement, a royalty agreement, a rental agreement, pricing terms, energy tariffs, and power-purchase agreements between supplier of energy and customers. The complexity for the financial terms makes it difficult to model, represent, document, implement and enforce compliance to the contractual financial obligations.

The disclosed technology involves a procedure with which the financial terms of a contract are modeled using rules. The present invention provides a general means for modeling the terms of a contract as a function of one or more parameters, where each of the one or more parameters is defined by one or more rules. A rule engine then evaluates and executes these rules, which are, for example, expressed as if-then statements. Based on the rules, the rule engine internally determines the order or the dependencies of the rules. Next, the rule engine determines which rule from the rule set to evaluate based on the input required for the rule as well as the results obtained from the evaluation of previous rules. Thus, the underlying idea of modeling the terms of a contract as rules, which are interpreted by a rule engine, is to separate the modeling of a contract from its implementation logic. This separation, in-turn, enables modeling changes to contractual terms as simple addition or deletion of rules from the rule set without requiring any change to the source code of the implementation logic.

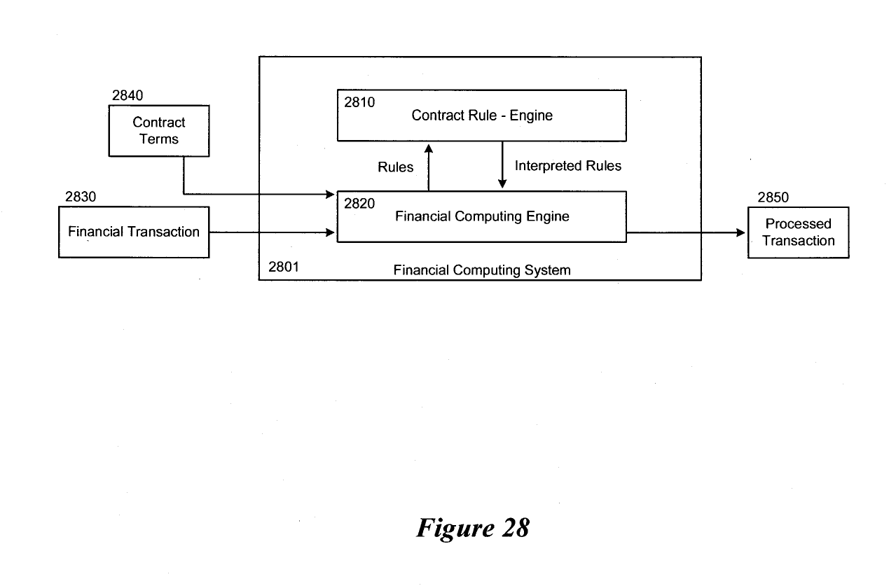

FIG. 28 is an illustrative embodiment of a financial computing system 2801, where financial terms from a contract are expressed as if-then rule statements. The financial computing system 2801 comprises a contract rule-engine 2810 and a financial computing engine 2820. The financial computing system 2801 receives the details of financial transactions 2830 and the terms of the contract 2840 governing the financial transactions 2830 as input. The financial computing system 2801 utilizes the financial computing engine 2830 to analyze the financial transaction for transaction details. Further, the financial computing system 2801 utilizes the financial computing engine 2820 to parse the contract terms into functions of various parameters. The financial computing engine 2820 parses parameters into sets of rules corresponding to each of the parsed parameter. Also, the financial computing system 2801 utilizes the financial computing engine 2820 to process transaction details based on the interpreted rules provided by the contract rule-engine 2810.

The financial computing engine 2820 forwards the set of rules corresponding to the various parameters to a contract rule-engine 2810. The contract rule-engine 2810 utilizes a rule engine to interpret the dependencies amongst the various rules corresponding to each given parameter. The contract rule-engine 2810 forwards the interpreted rules to the financial computing engine 2820. Using this interpreted relationship amongst the rules, the financial computing engine 2820 can then apply the transaction details to determine the outcome value for each parameter. In a different embodiment, the financial computing engine 2820 could forward the transaction details to the contract rule-engine 2810, which can then apply the transaction details to the interpreted rules to determine the outcome value for each parameter. The contract rule-engine 2810 could then forward the computed values of each of the parameters to the financial computing engine 2820. The financial computing engine 2820 utilizes the computed parameter values to determine the final transaction value, of which the parameters are a function of. The financial computing engine 2820 outputs the final transaction value as the value of the processed transaction 2850.

An example of the financial computing system disclosed in 2801 is discussed below. The financial system 2801 receives an invoice relating to a transaction and a contract governing the invoice. The financial computing system 2801 forwards the contract and the transaction details to the financial computing engine 2820. The financial computing engine parses the contract into a rule set corresponding to each of the parameters and related transaction state values. The financial computing engine 2820 forwards the contractual terms as rules to the contract rule-engine 2810. Based on the contract, one of the rule set representing the contractual term could be, if the customer's credit limit is greater than the invoice amount and the status of the invoice is “unpaid,” then decrement the credit limit with the invoice amount and set the status of the invoice to “paid.” A second rule from the rule set representing another aspect of the same contractual term could be, if the customer's credit limit is lower than the invoice amount and the status of the invoice is “unpaid,” then decrement the credit limit to zero and leave the status of the invoice unchanged, i.e. “unpaid.”

The financial computing engine 2820 also forwards the transaction state values to the contract rule-engine 2810. The contract rule-engine 2810 receives, as input, the transaction state values corresponding to the customer's credit limit, invoice amount, and payment status of the invoice. The contract rule-engine 2810 is given customer's credit limit as $5000, invoice amount as $2000, and payment status of invoice as “unpaid”. The contract rule-engine 2810 interprets the relationship of the rules, applies the input data to the interpreted rules and determines the final output. So, on analyzing the rule set, the contract rule-engine 2810 makes a determination that the two rules represent conditions that are mutually exclusive. Applying the transaction state value to the interpreted rule relationship, the contract rule-engine 2810 determines the customer's final credit omit and the status of the invoice. The contract rule-engine 2810 forwards the customer's final credit limit and the status of the invoice to the financial computing engine 2820. The financial computing engine 2820 sets the customer's final credit limit as $3000 and the status of the invoice as “paid”. Thus, the financial computing system represents a general means for modeling the terms of a contract without requiring any changes to the source code of the implementation logic.

In another illustrative embodiment of a general means for modeling contractual terms, the terms of a contract are modeled as a function of one or more parameters, where each of the one or more parameters is defined by a decision tree. The decision tree represents the relationship of the rules. The rules, as described above, are composed of two parts, a condition and an action: When the condition is met, the action is executed. The decision trees are composed of branches that have a condition node as their root, and end with actions. Every node is a condition node, except for leaf nodes. As will be appreciated, decision tree is a tree-like graph or model originally devised to model the possible consequences of decisions, outcomes of probabilistic event, cost of resource under different condition and economic utility of different choices. The disclosed technology repurposes the decision tree as a tool to model the financial terms of a contract. More specifically, the decision tree is used to represent various parameters associated with the financial terms, including the effective amounts of goods and services transacted per agreement between a buyer and seller, the effective rates with which a buyer agrees pay a seller for per unit of goods and services exchanged and scaling factors both parties agree to be used to modify the default rates under various contingencies and scenarios. Furthermore, the disclosed technology also employs the decision tree to describe alternative ways to value transactions and agreements between a buyer and a seller as to which should be used to value the transactions between them (e.g., greater, lesser or arithmetic mean of two alternative valuation methods).

With such a procedure, the conditions under which the rates are applied to transactions, accounting of effective units transacted and scaling factors specified are listed first. A decision tree is then constructed using these conditions, in which the decision branching of each tree corresponds to the associated conditions. Finally, the leaf nodes of the tree are used to specify, e.g., the effective accounting of amount of goods and services transacted, default rates per unit or scaling factors per an agreement. Once the financial terms of the contract are modeled, the decision tree can be traversed on a case by case basis to quickly determine the effective amount transacted, default rates and scaling factors for a specific combination of conditions.

Lastly, the disclosed technology uses arithmetic combination of the decision trees to model financial terms of contracts in the most generalized ways. With such a model, the financial commitment a buyer makes to a seller can be expressed generally in terms of arithmetic functions of multiple decision trees. FIG. 6 illustrates an example wherein the financial terms of a contact can be represented by an arithmetic function of three decision trees. According to the present teaching, a contracted payment can be calculated as a function of multiple parameters, where each parameter is described a decision tree. In the example of FIG. 6, the contracted payment is an arithmetic function of three parameters: “transaction amount,” “rates” and “scaling factor.” These three variables are each arithmetic functions of three decision trees specifying effective amount of goods and services transacted, default prices and scaling factors used respectively under various conditions and scenarios per the agreement between a buyer and a seller. A special case involves the multiplication function of three decision trees, while other arithmetic relationships can also be modeled.

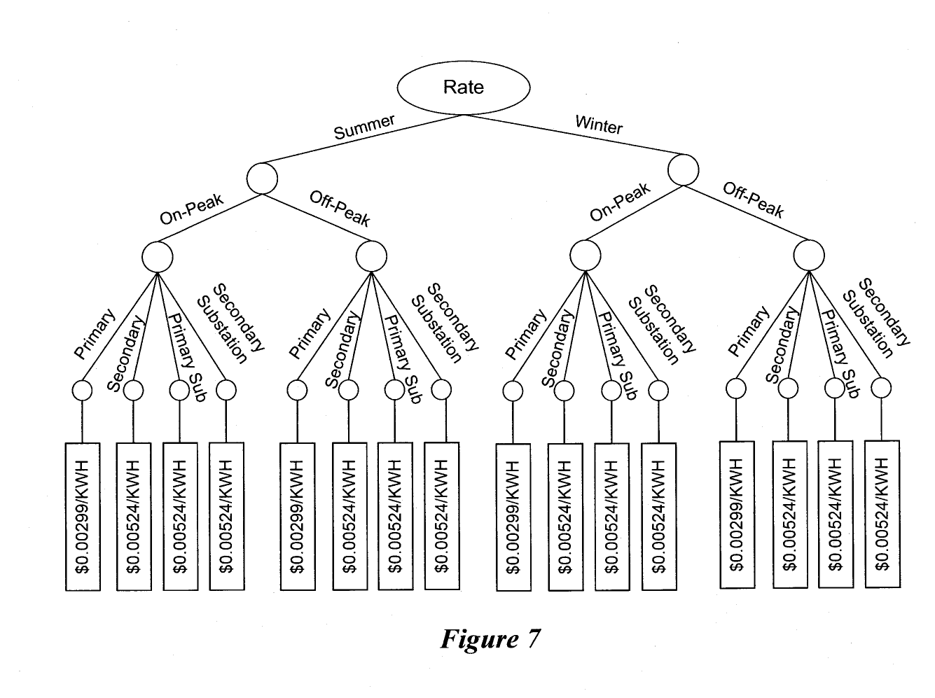

With reference to FIGS. 7-13, the disclosed technology is applied to model the financial terms of various real contracts.

FIG. 7 is a pictorial illustration of a decision tree 100 that models the financial terms of a utility retail tariff, a contract between the utility (the seller of energy) and a customer (a buyer of energy), which is based on a number of circumstances, as defined by a set of conditions. These conditions include the season of the year and time of the day when the transaction takes place and the voltage level as applied to the customer buyer. The decision tree specifies the pricing rates under these circumstances. In order to calculate the pricing term, the decision tree 100 must be traversed according to the circumstances.

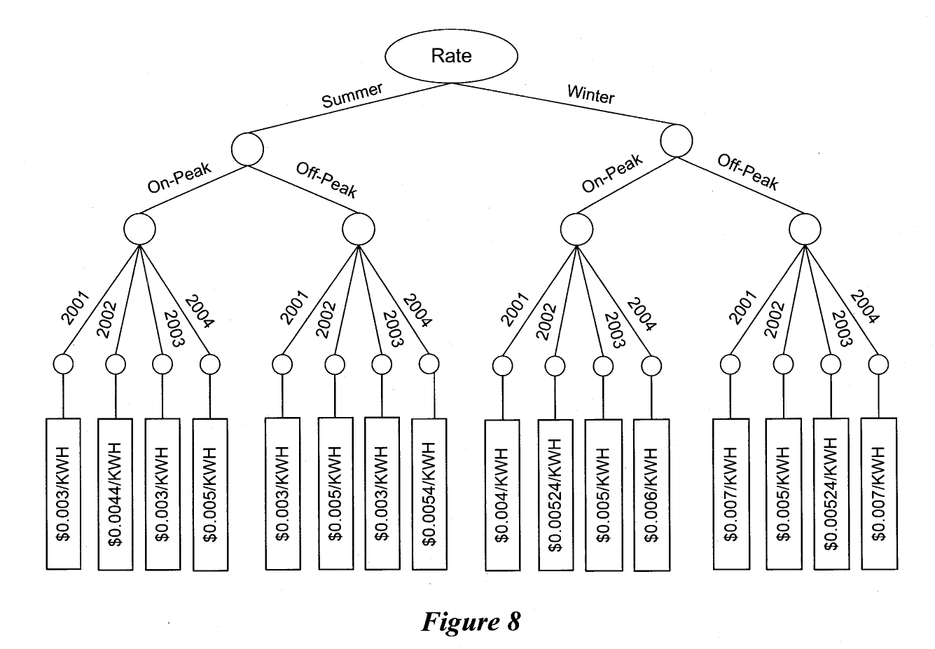

FIG. 8 is a pictorial illustration of the financial terms of utility Feed-in-Tariff, a contract between the utility (the buyer of energy) and a customer (the seller of energy). Similar to FIG. 7, the decision tree in FIG. 8 models the prices with which the utility pays to its customer to buy the energy generated from his/her rooftop solar photovoltaic system. In this case, the prices with which the utility buys energy from the customer depends on the circumstances including the season of the year (Summer or Winter), time of the day (Peak hours, Semi Peak hours or Off Peak hours) and finally the start year of the contract (2001, 2002, 2003 or 2004).

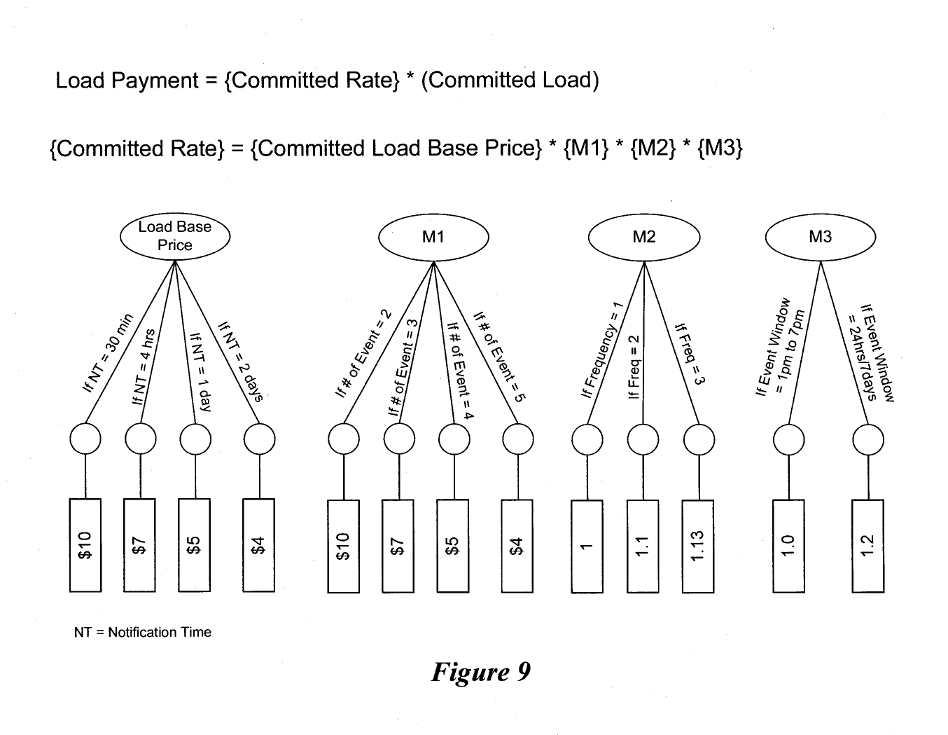

FIG. 9 is a pictorial illustration of the financial terms of a demand response contract between a utility and its demand response customer, with which the customer (the seller) sells the rights to reduce its energy consumption to the utility (the buyer) in exchange for utility payments. Under the terms of the contract, the utility payment to the customer is the product of Committed Rate, a decision tree, and Committed Load, a variable. Committed Rate is the product of four decision trees including Committed Load Base Price and three modification factors. Committed Load Base Price varies based on Notification Time, the time when the demand response event is called before the load reduction. Modification factor #1 is based on the number of events is called, modification factor #2 on the frequency these events are called and modification #3 on time of the day the events are called.

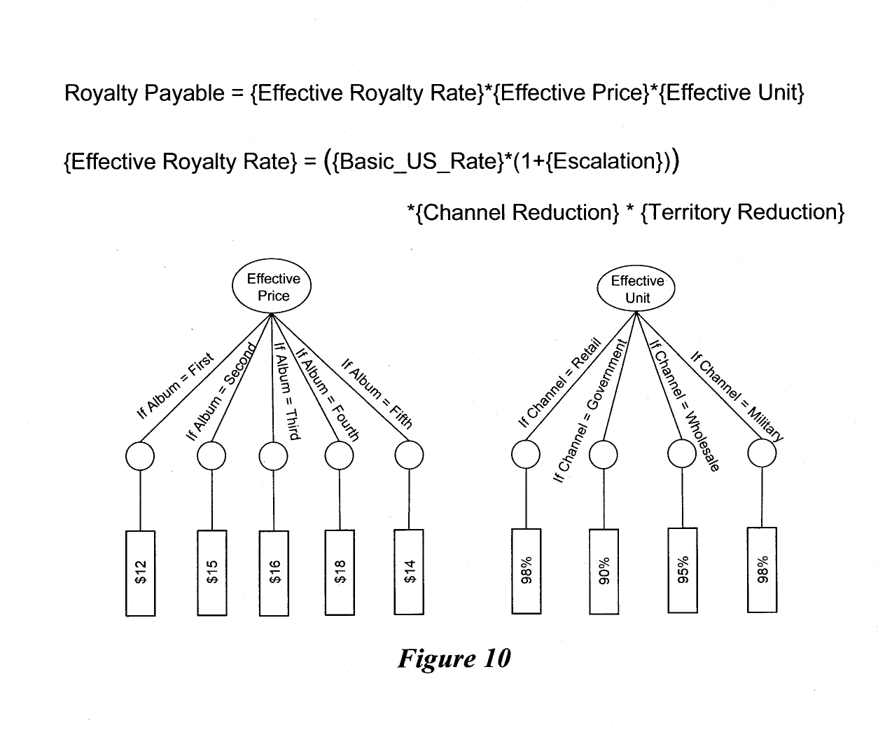

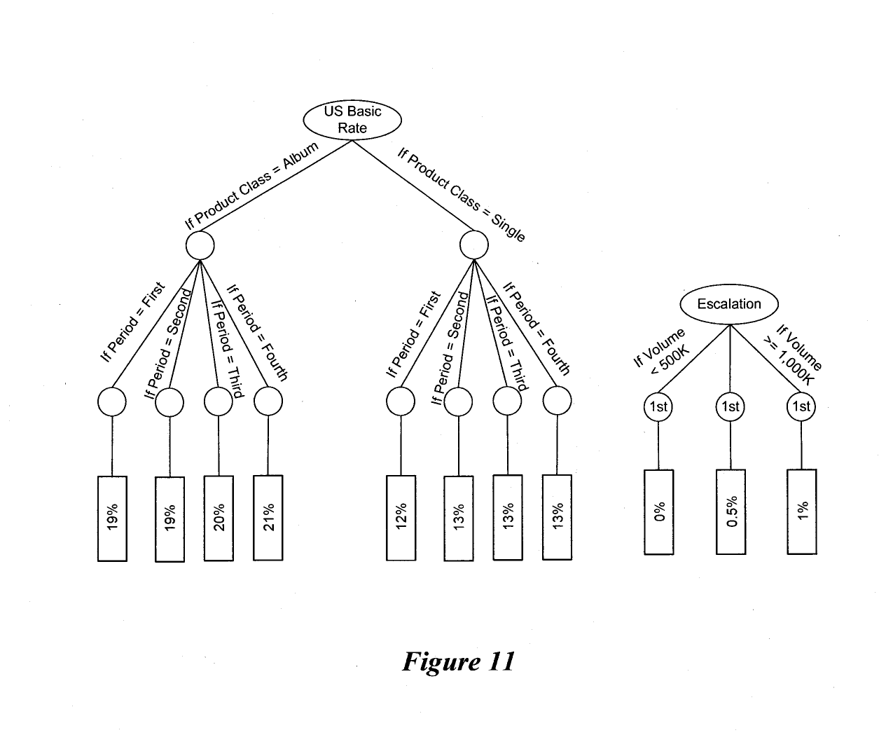

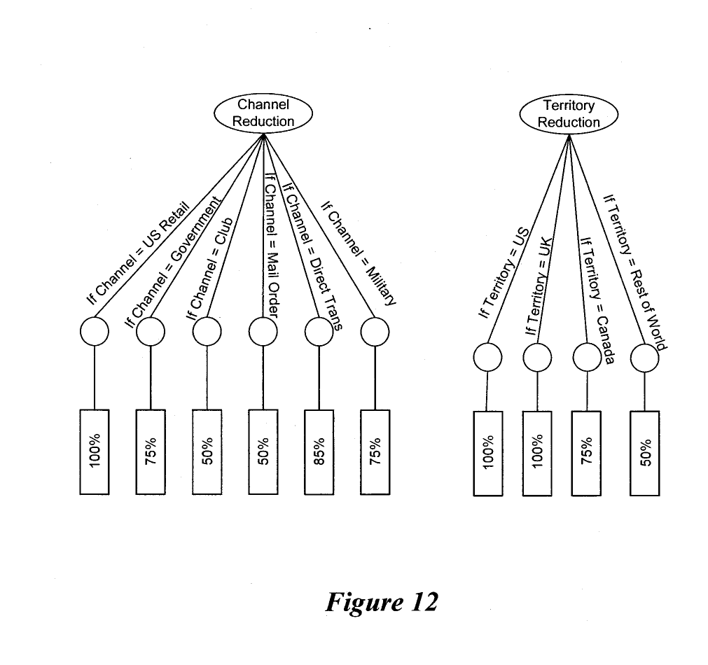

FIGS. 10-12 collectively is a pictorial illustration the financial terms of a royalty contract between a music label (the buyer of rights to a musical composition) and an artist (the seller of rights) using the disclosed technique. As indicated in FIG. 10, the contracted payment from the music label to the artist has three key components: the effective units of transacted, effective royalty rates and effective royalty. The effective royalty rate is determined by Basic Rate in the US territory, a volume based escalation factor, channel-based reduction factor and territory dependent reduction factor. Each of the components itself is a decision tree. Under such an agreement, the effective units used in calculating the royalty payable to the artist is based on the units sold in the retail stores less the number of promotional units and allowed shrinkage and depends on the distribution channels. The base retail price used in calculating the royalty payable is based is the US list price and dependent the specific album or CD sold in the retails. The Effective Royalty Rate used in calculating royalty payable to the artist is itself an arithmetic function of four decision trees. Basic US Rate is the base royalty rate and depends on the product class (album or single) and production period (first, second, third or fourth). Escalation is the uplift in royalty rate by small percentage based on the cumulative release volume, which is tiered based on volume thresholds (see FIG. 11). Channel reduction and territory reduction are discounts from the base rate in the US and depends on the distribution channels outside of the US retails and territories outside of the US (see FIG. 12).

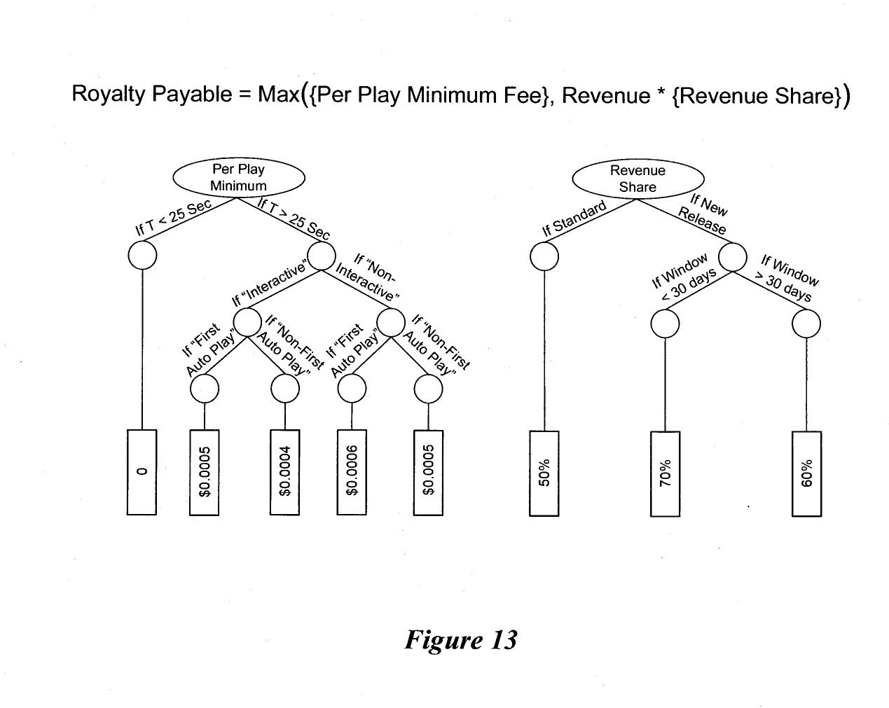

FIG. 13 is a pictorial illustration of the financial terms of licensing contract between a music label and an online advertising-supported music retailer, as expressed using the disclosed technology. According to the licensing contract, the payable by the music licensee to the licensor is the greater of Per Play Minimum fee and a share of online advertising revenue, each being a decision tree. Per Play Minimum is calculated based on duration of the music stream (greater than 25 second or less that 25 second), interactivity (Interactive or Non-interactive) and auto-play mode (First Auto Play or Non-First Auto Play). The online advertising revenue share is calculated based on catalog type (New Release or Standard) and release window (greater than 30 days or less than 30 days).

In one embodiment processor electronics are programmed with appropriate data model and executable instructions to allow a user to create decision trees to model various contract terms. The modeling can be accomplished by providing a graphical user interface enabling a user to build relevant decision trees by prompting the user for specific elements and parameters of a contract. The decision tree could be constructed and populated in real time, and displayed to the user for easy review. Alternately, a written contract could be mapped into a form template that in turn can be converted into a decision tree. Likewise, the contract could even be drafted according to a specific language such as HTML or XML, which enables ready conversion into a computer representation of the decision tree(s). In a step 184, the decision tree model of the financial contract terms is represented in memory and saved in a configuration file of a computer system. The configuration file, data model and executable are package as a library which is distributed to the processing nodes.

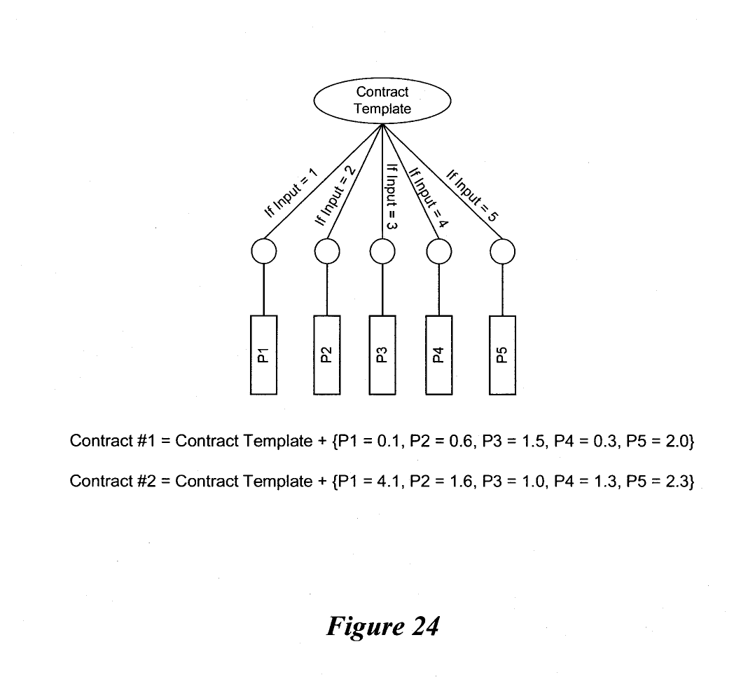

In addition to modeling the financial terms of contracts, the disclosed technology also use decision tree to model the contract template, a parameterized decision tree that is used to model the common structure of a category of similar contracts. FIG. 24 illustrates the use of a decision tree as a contract template. By combining the contract template with one or multiple set of parameters, contracts of the same structure and yet different rate parameters can be modeled. Such contract templates further increase the disclosed technology's capability to handle a large number of contracts efficiently.

In addition to decision tree based method, the disclosed technology also postulates a scheme that involves decision table and other modified tabulation formats.

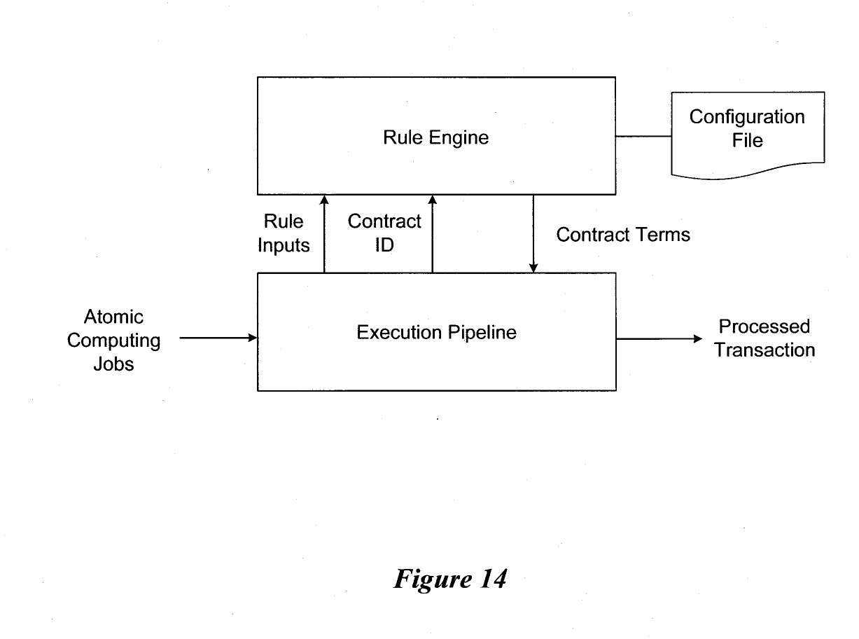

FIG. 14 is a pictorial illustration of how the contract rule engine is used. The representation could be found as executable code, and could be derived directly from the building of the decision tree(s) in step 182. In a step 186, the details of a specific financial transaction are received at the computer system. These could be manually entered, but more likely the current system would be executing a mass number of transactions so that the model is coupled to an execution pipeline that derives input conditions from transactions, provides the details of the input conditions to the contract rule engine and receives information about the financial terms of the contracts. In a step 188, usage, pricing and adjustment factor are determined by traversing the decision tree(s). In a step 190, the payment under the contract is calculated.

### Clearing Financial Transactions

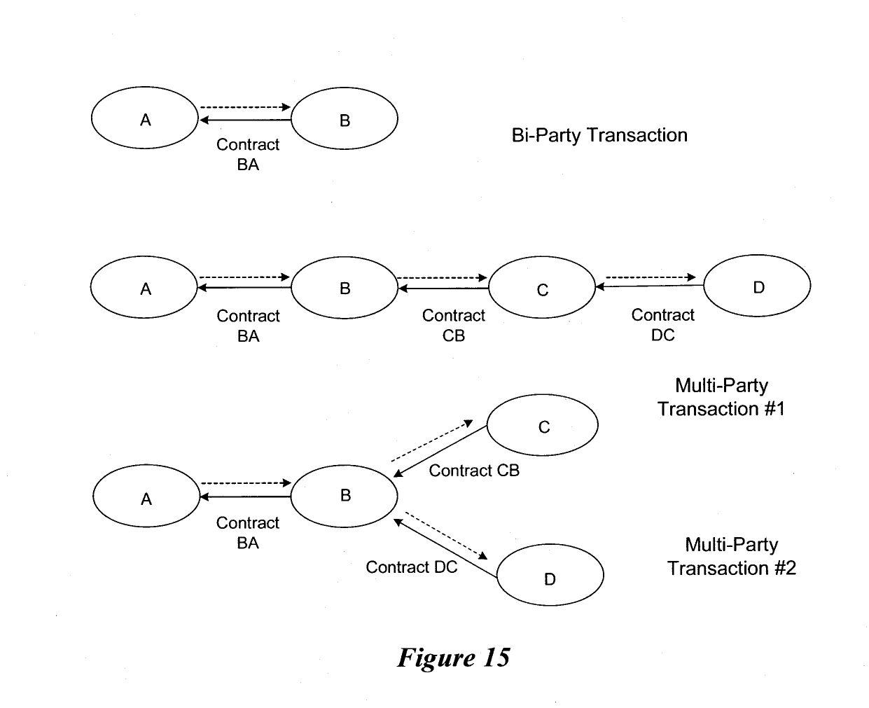

In addition to modeling the financial terms of contracts in the generalized ways, the disclosed technology employs a new method to clear, based on the contractual terms, bi-party and multi-party financial transactions to determine the financial positions of the parties involved. FIG. 15 illustrates such bi-party and multi-party transactions. In a bi-party transaction between a Buyer A and Seller B, Buyer A buys goods and services from Seller B and remits payments to Seller B, based on Contract BA. In a multi-party transaction, A buys from B certain goods and services part of which is bought from C and part of what B buys from C is sourced from D. Upon completion of the multi-party transaction, A pays B based on Contract BA, B pays C based on Contract CB and C pays D based on Contract DC. In the first leg of the multi-party transaction, A is the buyer and B is the seller; in the second leg, B is the buyer and C is the seller; in the third leg, C is the buyer and D is the seller. Only the first leg of the transaction is captured in a transaction record and the subsequent legs of transaction must inferred from the transaction record. Note that C and D get paid, only after the transaction between A and B takes place. Therefore all legs of the transaction must be processed at the same time in order to maintain the transaction integrity.

A variation of the multi-party transaction involves B buying from C and D and therefore pays C based on Contract CB and D based on Contract DB, respectively. In this case, A is the buyer and B is the seller in the first leg of the multi-party transaction, B is the buyer and C and D are the sellers in the second and third legs. Similarly, all legs of the transaction must be processed at the same time in order to maintain the transaction integrity.

Examples of such multi-party transactions involve a content aggregator B selling a bundle of content (e.g., music tracks) or a single content (e.g., single music track) with a bundle of rights to customer A. A component of the content is licensed from rights-holder C and/or rights-holder D.

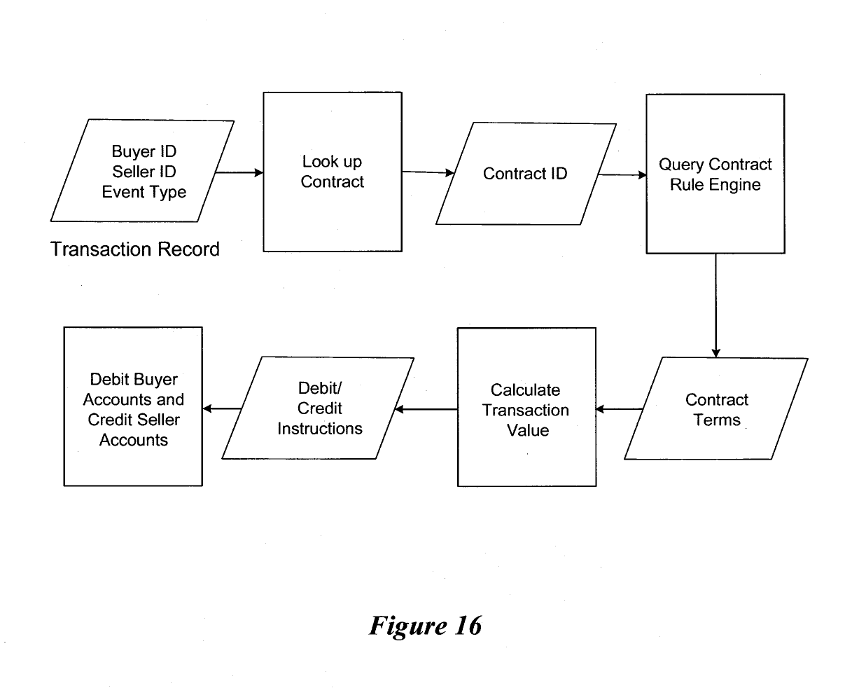

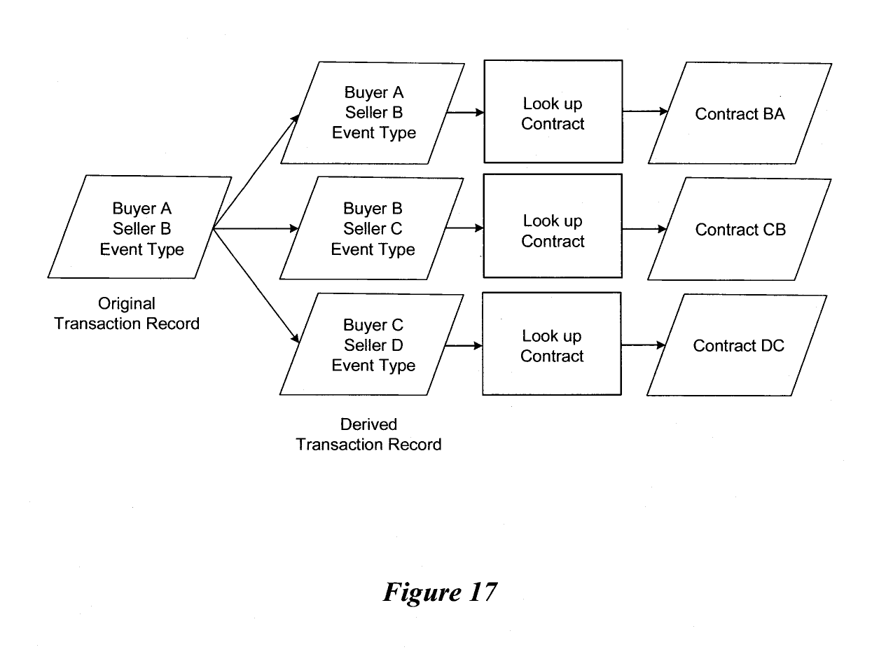

FIG. 16 is a flow chart description of the bi-lateral financial clearing process and FIG. 17 is a flow chart of multi-lateral financial clearing process.

As illustrated in FIG. 16, the first step in clearing a transaction between a Seller A and a Buyer B, is to look up the appropriate contract based on buyer ID, seller ID and Event Type. Once the contract is identified, the processing pipeline queries the contract rule engine with the contract ID for the appropriate financial terms by traversing the decision trees and calculates the transaction value. The transaction value is then calculated. The amount is debited from buyer's accounts and the same amount is credited for the seller's accounts.

As illustrated in FIG. 17, the disclosed technology decomposes the multi-party transaction clearing into clearing multiple related bi-party transactions simultaneously. The original three-party transaction record must first be transformed into a set of bi-party transaction records. These derived transaction records, together with buyer ID, seller ID and Event Type, are then used to find the appropriate contract. The contractual terms are then used to calculating the transactions value before debit and credit operations are made to the buyer and seller.

To avoid partial transactions and maintain transaction integrity, the disclosed technology features a financial clearing execution engine that treats the derived transactions as a complete transaction set. If one of such bi-party transactions fails, the others must be aborted, until all derived bi-party transactions are processed correctly.

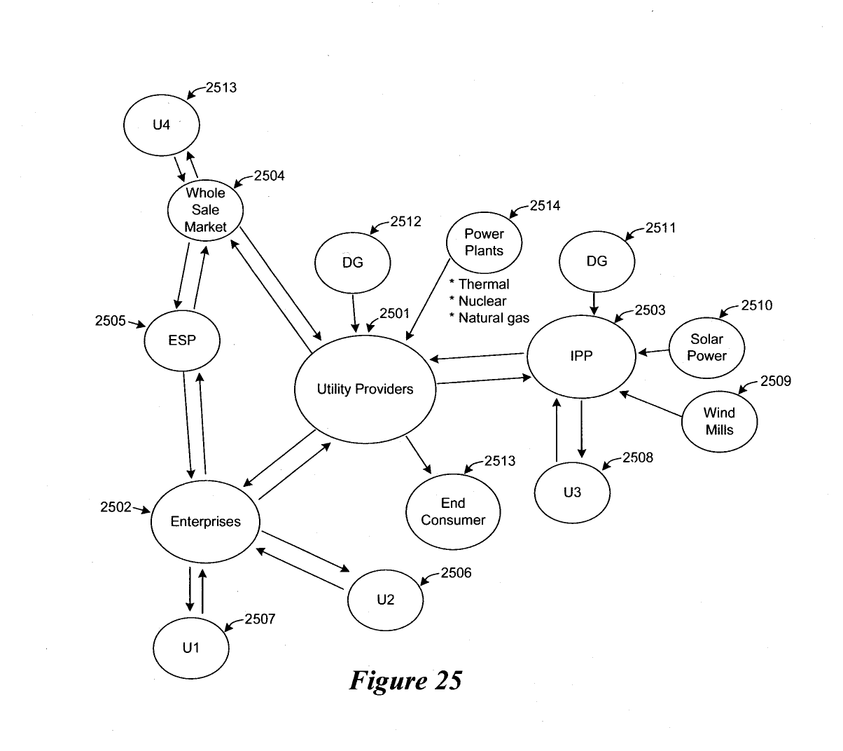

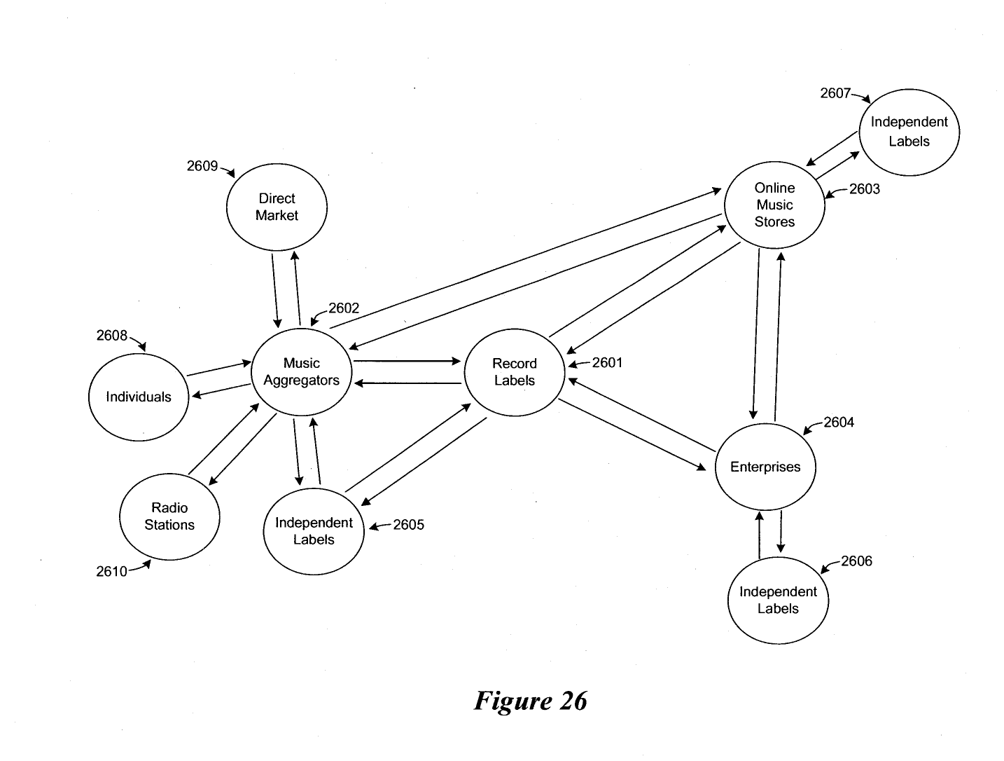

FIG. 25 and FIG. 26 illustrate industry scenarios where the above disclosed complex, multi-party transactions are regularly handled. FIG. 25 illustrates the various parties and the transactions amongst them in the energy market. FIG. 26 illustrates the various parties and the transactions amongst them in the licensing of copyrighted music.

As illustrated in FIG. 25, the energy market is composed of multiple parties, where some parties participate in both buying and selling of energy while others participate in either buying or selling energy but not both. Furthermore, each party could be transacting with multiple parties in the energy market at the same time.

One of the primary players in the energy market are the Utility Providers 2501 who regularly transact with multiple parties in the energy market. The Utility Providers 2501 generally connect the end consumer 2513 of energy with the various energy providers. The Utility Providers 2501 could be of various types. The Utility Providers 2501 could be Investor Owned Utilities (“IOU”), Public Owned Utilities (“POU”), Municipal Owned Utilities (“MOU”), or Coop Owned Utilities (“COU”). The Utility providers generally meet their energy requirements through their Power Plants 2514, Diesel Generators (“DG”) 2512, etc. Such transactions need to be regularly settled to maintain proper accounting.

The Utility Providers 2501 also regularly trade energy in the Whole Sale Energy Market 2504 (“WSEM”), where the Whole Sale Energy Market 2504 provides a platform for various energy providers and consumers to trade in the energy market. Such transactions usually involve settling multi-party transactions, where the total energy purchased by a Utility Provider 2501 could have been aggregated together from multiple, independent energy providers, such as another Utility (“U4”) 2513, an Energy Service Provider (“ESP”), etc. to meet the entire energy requirement of a Utility Provider 2501. When settling such transactions, the WSEM needs to employ a transaction clearing house, where each transaction involving multiple parties are grouped into sets of bi-directional buyers and sellers. The transactions are further ordered and executed such that the integrity of the transactions is always maintained.

The Utility Providers 2501 also regularly trade energy with Independent Power Producers 2503 (“IPP”), such as individual households, who not are not only consumers of energy but are also producers and sellers of energy. The IPPs 2503 produce energy using solar power 2510, windmills 2509, diesel generators (“DG”) 2511, etc. that are installed on the IPPs' 2503 property. Further, the IPPs 2503 could be trading energy amongst themselves and with other parties in the energy market using the infrastructure of the Utility Provider 2501. The Utility Provider 2501 will be able to charge the IPP 2503 a fee for using its infrastructure. In such a scenario, the Utility Provider 2501 also acts as a clearing house between the various buyers and sellers of the IPPs' 2503 energy. When settling such transactions, the Utility Provider 2501 needs to employ a transaction clearing house, where each transaction involving multiple parties are again grouped into sets of bi-directional buyers and sellers. The transactions are further ordered and executed such that the integrity of the transactions is always maintained.

Other than the individual End Consumers 2513, some of the biggest customers for most Utility Providers 2501 are Enterprises 2502, which could be any consumer of energy using high tension lines. The Enterprises 2502 are heavy consumers of energy, who generally purchase energy from multiple utilities 2506, 2707. The Enterprises 2502, similar to IPPs 2503, sometimes also produce their own energy and have it wheeled to their location using the Utility Providers 2501 infrastructure. Further, the Enterprises 2502 trade with Utility Providers 2501 to offset their energy consumption at one location using energy produced by their self-owned power plants, solar cells, etc. at another location. Each such complex transaction requires the Enterprises 2502 to employ a clearing house to quickly process the transactions while maintaining the integrity of the process.

As illustrated in FIG. 26, the music licensing market is composed of multiple parties, where some parties participate in both buying and selling of music licenses while others participate in either buying or selling music licenses but not both. Furthermore, each party could be transacting with multiple parties in the music licensing market at the same time.

One of the primary players in the music licensing market is the Record Labels 2601 who regularly transact with multiple parties in the licensing market. The Record Labels 2601 generally produce their own copyrighted music with the Artists who have signed up with the Record Label 2601. The Record Labels 2601 license their music catalogue in the market either through their own stores, or through Online Music Stores 2603, such as iTunes, Amazon Music, etc. Further, the Record Labels 2601 could purchase and market music produced by other Independent Labels 2605 for a fee. For each such transaction, where, for example, a Record Label 2601 licenses a music from a Independent Label 2605 and sub-licenses it Online Music Stores 2603, the Record Label 2601 needs to employ a clearing house to ensure the proper payment from the Online Music Store 2603 to the Independent Label 2605. Also, in such transactions, the clearing house should ensure the Independent Label 2605 is only paid after the Record Label 2601 is paid by the Online Music Store 2603 and that the Record Label 2601 receives its fees before the Independent Label 2605 receives its licensing fees.

The Record Labels 2601 also regularly buy and sell license from Music Aggregators 2602, such as Music Reports, whose primary task is to identify and purchase license based on the licensing requirements of their customers, such as Radio Stations 2610, Individuals 2608. The Individuals 2608 could be film makers, cover bands, etc. Similar to the Record Label 2601, the Music Aggregators 2602 regularly need to clear transactions involving multiple parties, where the sellers could be Record Labels 2601 and Independent Labels 2605, and the buyers could be Radio Stations 2610, Individuals 2608, Online Music Stores 2603, Direct Markets 2609 etc.

Other than the Music Aggregators 2602, the Record Labels 2601 also regularly buy and sell license from Enterprises 2604, such as film studios. The Enterprises 2604, in turn, buy and sell licenses from other parties, such as Independent Labels 2606, Online Music Stores 2603, etc. in the music licensing market. The Enterprises 2604 also regularly need to clear transactions involving multiple parties, where the sellers could be Independent Labels 2606, and the buyers could be Online Music Stores 2603, etc.

FIG. 25 and FIG. 26, as disclosed above, thus illustrate industry scenarios where complex, multi-party transactions can be cleared using the transaction clearing mechanism described in our invention.

### High Throughput Low Cost Financial Transaction Processing

In addition to a generalized way to model contractual relationships between buyers and sellers, apply these contracts to determine the value of the transactions, and update the financial accounts for the buyers and sellers, the disclosed technology involves a method to process a large volume of transactions efficiently and quickly.

Most conventional methods of processing financial transactions are based on relational databases. However, these existing methods, while maintaining transaction integrity are significantly limited in throughput due to the latency involved in storing data to and retrieving data from the database.

Before transactions can be processed financially, the transactions must undergo a set of pre-processing, including validation of elements of the transaction records, making corrections if erred, incorporation of additional information needed to correctly apply the contacts. The disclosed technology implements such pre-processing logics using a file system to increase the throughput of transaction pre-processing.

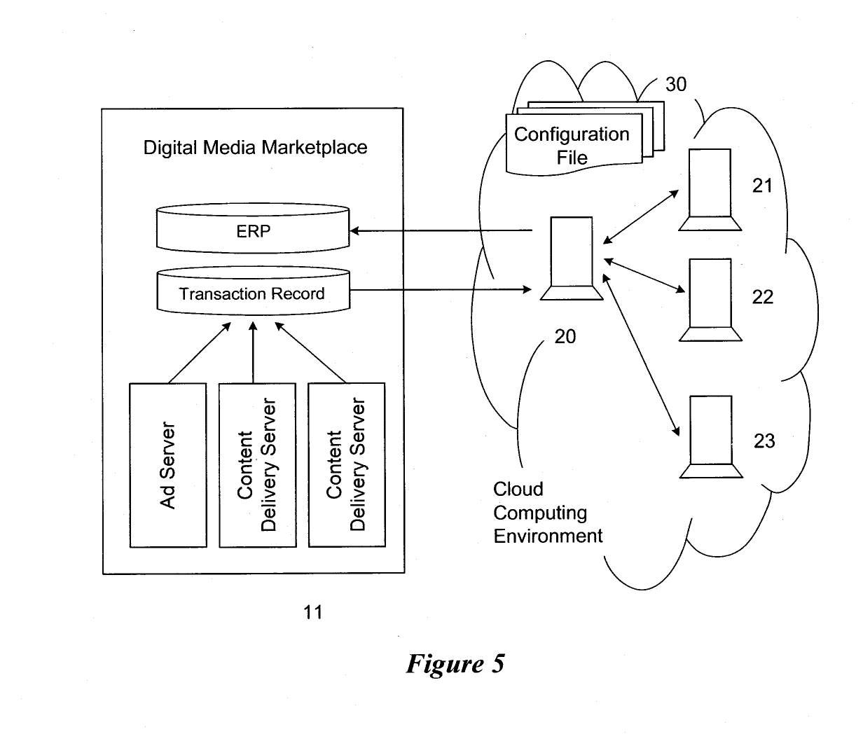

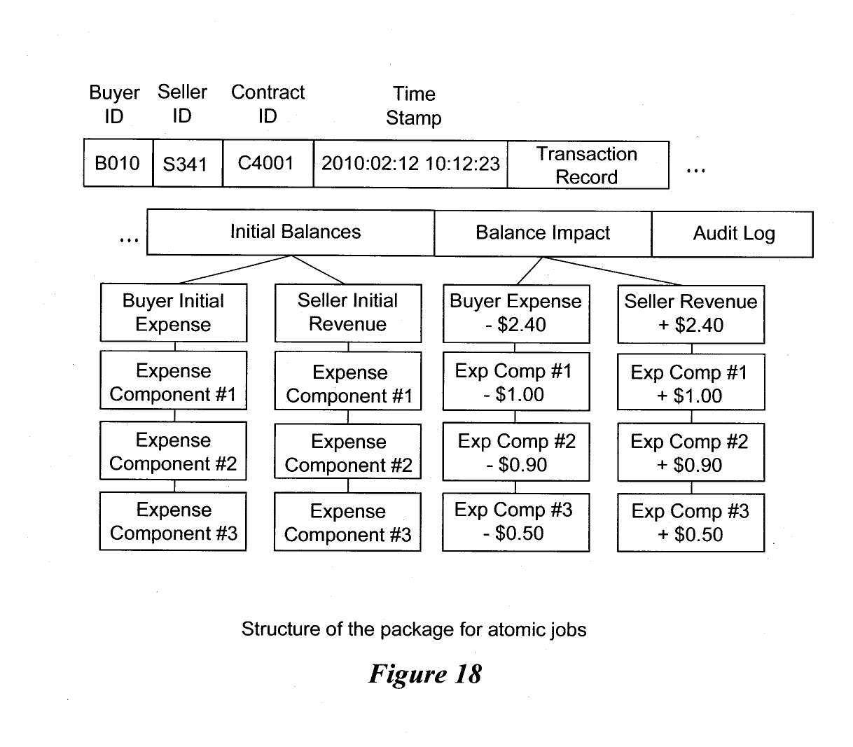

As illustrated in FIGS. 4 and 5, the transaction records are imported and processed by a computer system 20 that packages the transactions into a number of atomic computing jobs 30, 31 and 32 etc. that are sent to one of a number of networked computers or processing nodes 40, 41 and 42 in a cloud computing environment 50. In one embodiment, each atomic computing job 30, 31, 32 contains sufficient information to clears the financial transactions between a buyer and a seller. The information may include the identification number for the buyer or the seller and the identification numbers of one or multiple counter-party's with whom the buyer or seller has either buying or selling contracts, the identification numbers of the respective contracts that governs the financial terms of the energy buying and selling transactions, the respective starting account balances for the buyer and seller, and other information (as shown in FIG. 18). The atomic computing jobs 30 also include a number of transaction records for the particular buyer and seller as related to his buying and selling transactions. By packaging and storing all input and output account balances and other necessary information for transaction processing together with the transactions, such atomic computing jobs save the processing nodes from accessing account balances remotely across a network and hence increase the processing throughput.

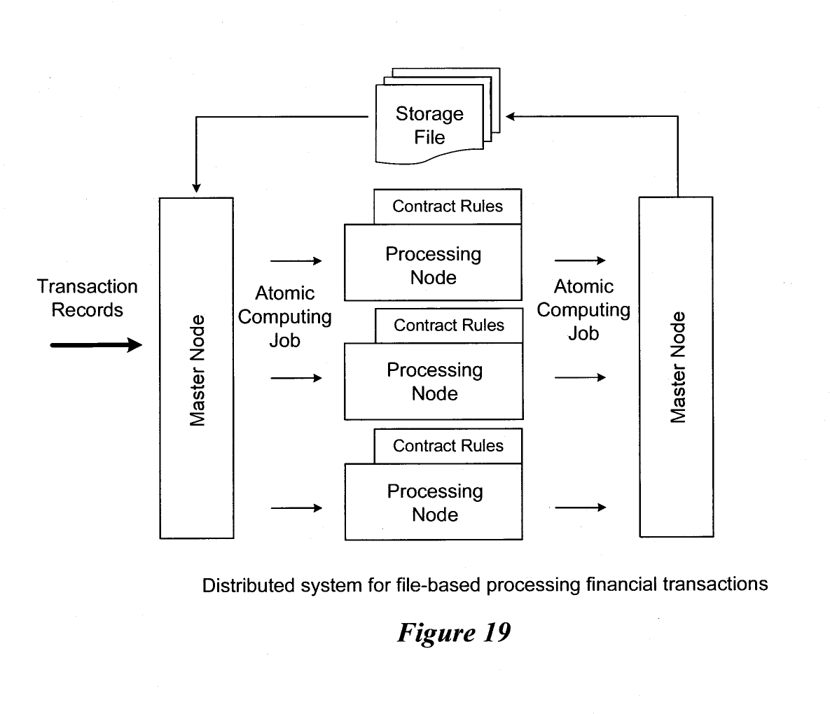

In FIG. 19, the atomic computing jobs are then dispatched to one or multiple processing computers, in which the terms of the appropriate contracts will be looked up by querying a rule engine with the contract identification numbers and other input parameters and the contractual terms are then applied to the transaction records and appropriate debits and credits are calculated in compliance with the terms of the contracts and stored temporarily by appending the atomic computing jobs. Finally, a separate computer tallies these debits and credits and the appropriate debit and credit operations are made to the accounts stored in the atomic computing jobs. In an alternative embodiment, the processing node that generates the atomic jobs may instruct other processing nodes in the cloud computing environment to process one or more atomic jobs.

The terms of all contracts between buyers and sellers in a marketplace are defined in a contract rule engine, which is dispatched to and integrated with the processing nodes as a library. The contract identification number and other inputs required by the contract rule engine are used to query the rule engine to obtain a set of contracted rates, which are used by the processing nodes to calculate the value of the transactions correctly and accurately.

Upon completion of processing a batch of the atomic computing jobs, the processing node 40 updates the storage file with all of the account balance changes. The updated storage file is then transported back to the non-transitory storage node and the balances are transferred and updated to the file system or a database. The storage file or database is used to package a new batch of computing jobs when a new batch of transactions is to be processed.

The computer system 20 receives the modified storage file and generates a bill for a buyer from a seller. In some embodiments, the bill generated may aggregate multiple mini transactions. In other embodiments the customer may be billed for each mini transaction.

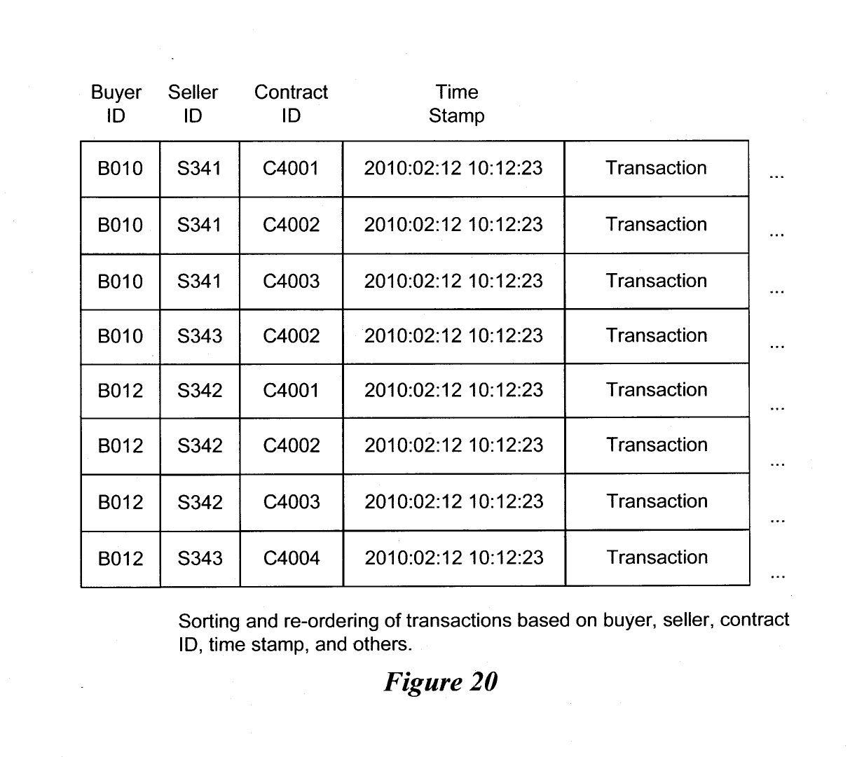

To further improve the transaction throughput, the disclosed technology uses techniques such as sorting and re-ordering of transactions to aggregate like transactions (see FIG. 20). In one embodiment, the sorting involves two stages: sorting by contract and by account/entity. In other embodiment, the sorting may involves additional stages.

To increase the transaction processing efficiency and throughput, multiple transactions are bundled into a batch so that they can be processed at the same time.

To maintain the transaction integrity and reliability, the disclosed technology employs one or more measures for check pointing and reprocessing of transactions in the event of a transaction processing failure. In one embodiment of the technology uses a check-pointing and re-trying scheme, in which a copy of the input atomic computing job is duplicated in the local or a remote processing node. If the atomic job is processed successfully, the duplicate copy will be discarded. If the atomic job is processed unsuccessfully, the duplicate atomic job will be used for re-processing. Such re-starting and re-processing scheme in the event of transaction processing failure is repeated until the job is processed successfully.

The most basic configuration of the disclosed technology consists of a non-transitory computer readable storage containing a sequence of programmed instructions that are executable by processor electronics to produce a storage file and send it to a processing node and a procedure to carry out reliable financial transaction processing. With such a configuration, the transaction processing rules as specified by the contractual arrangements between buyers and sellers and their respective account balances used to keep track of the value exchanges between buyers and sellers are stored in the non-transitory storage in the form of a file system or database.

Before processing a new batch of transactions, the computer 20 packages the transactions together with the most updated information from the storage file. Such scheme ensures that the most up to date account balances are used to process the transactions. Similarly, a rule file is updated and distributed to processing nodes with which the contract rule engine is integrated. New processing rules, as a result of changes in contractual arrangements between buyers and sellers, and new account balances, as a result of adjustments, can be updated between processing two jobs.

A variation of the above described technology is to use a relational database as a non-transitory computer storage to make it easier to develop a software application to manage the processing rules for transactions between buyers and sellers and to track account balances for the buyers and sellers. The use of a database also makes it easier for other applications to query for information. With such a variation, the processing rules and account balances that stored in the relational database are converted into a storage file and distributed to a processing node to be used for transaction processing. The returned results of the processing are then updated into the relational database.

Another more sophisticated variation of the disclosed technology involves the use of a distributed file system and multiple distributed processing nodes (see FIG. 19). The distributed file system can be used to partition and distribute pieces of the storage file and the transactions to multiple processing nodes. Each node processes a subset of the transactions independently and on parallel.

In an embodiment, the disclosed technology is implemented using Map Reduce computing model and open-sourced Hadoop software. Hadoop Distributed He System (HDFS) is used to distribute the storage file to local processing nodes, while Hadoop Map Reduce is used to package atomic computing jobs and process transactions parallel.

### High Throughput Smart Meter Data Pre-Processing Using File Systems

To construct financial records for buying and selling energy and non-energy transactions in the smart grid with high throughput and scale, the disclosed technology employs file or distributed file systems to pre-process the meter reading data, while the prior arts employ relational database. The pre-processing of meter data and generation of the financial transaction records involve one or more sub-processes employed to validate the correctness of the meter reading data, correct for erred meter data, estimate and interpolate missing meter reading data, elimination of outliers, detect and eliminate duplicate meter data, aggregate like transactions into single transaction, and enrich the meter data with related information so that the contractual terms can be applied during financial transaction processing.

### Implementation

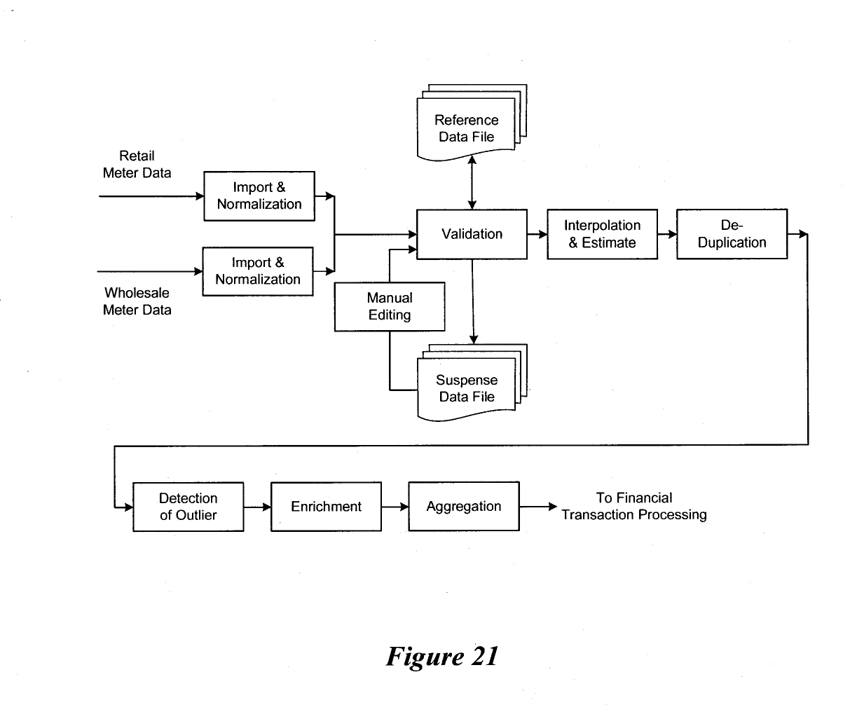

The disclosed technology consists of three major components: Marketplace Management System (MMS), storage file and a set of execution engines including data pre-processor, clearing engine and post-processor (see FIG. 21). The execution engines are supported by a number of networked processing nodes, which process transactions in parallel.

MMS is a web-based application used to configure and manage a marketplace, including entities participating in the marketplace and the inter-entity contractual arrangements. As new entities participant in the marketplace and contracts are added, MMS is used to configure the new entities and contracts. In addition, MMS is used to revise the entities and contracts systematically. The configured data model, stored in the storage file, is used to configure the execution engines. Data Pre-Processor is used to validate, cleanse and condition input data so that high quality transaction records can be derived. One or multiple of processing nodes may be involved to increase the throughput of Data Pro-Processor. Clearing Engine is the core transaction processor which applies the contractual terms and others information to the transactions and makes debit and credit entries to buyer and seller entities involved in the transactions. Similarly, one or multiple processing nodes may be involved to increase the throughput of Clearing Engine. Each one of the processing nodes associated with Clearing Engine is integrated with a contract rule engine which is configured with the contractual terms of all of the contracts involved in the marketplace. The cleared transactions may be further processed and aggregated by Post-Processor.

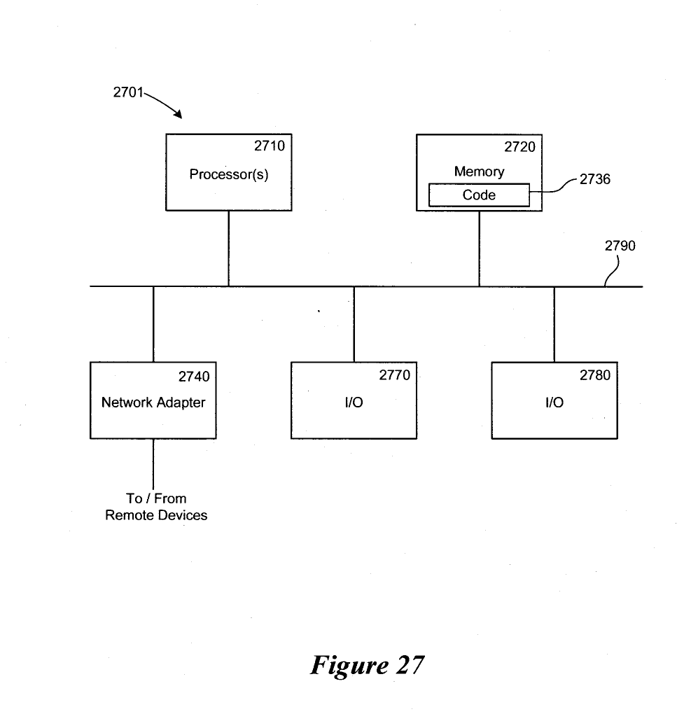

FIG. 27 is a block diagram of a processing system that can be used to implement any of the techniques described above, such as a financial computing system, a clearing engine, a contract rule-engine or a financial computing engine. Note that in certain embodiments, at least some of the components illustrated in FIG. 27 may be distributed between two or more physically separate but connected computing platforms or boxes. The processing can represent a conventional server-class computer, PC, mobile communication device (e.g., smartphone), or any other known or conventional processing/communication device.

The processing system 2701 shown in FIG. 27 includes one or more processors 2710, i.e. a central processing unit (CPU), memory 2720, at least one communication device 2740 such as an Ethernet adapter and/or wireless communication subsystem (e.g., cellular, WiFi, Bluetooth or the like), and one or more I/O devices 2770, 2780, all coupled to each other through an interconnect 2790.

The processor(s) 2710 control(s) the operation of the computer system 2701 and may be or include one or more programmable general-purpose or special-purpose microprocessors, microcontrollers, application specific integrated circuits (ASICs), programmable logic devices (PLDs), or a combination of such devices. The interconnect 2790 can include one or more buses, direct connections and/or other types of physical connections, and may include various bridges, controllers and/or adapters such as are well-known in the art. The interconnect 2790 further may include a “system bus”, which may be connected through one or more adapters to one or more expansion buses, such as a form of Peripheral Component Interconnect (PCI) bus, HyperTransport or industry standard architecture (ISA) bus, small computer system interface (SCSI) bus, universal serial bus (USB), or Institute of Electrical and Electronics Engineers (IEEE) standard 1394 bus (sometimes referred to as “Firewire”).

The memory 2720 may be or include one or more memory devices of one or more types, such as read-only memory (ROM), random access memory (RAM), flash memory, disk drives, etc. The network adapter 2740 is a device suitable for enabling the processing system 2701 to communicate data with a remote processing system over a communication n link, and may be, for example, a conventional telephone modem, a wireless modem, a Digital Subscriber Line (DSL) modem, a cable modem, a radio transceiver, a satellite transceiver, an Ethernet adapter, or the like. The I/O devices 2770, 2780 may include, for example, one or more devices such as: a pointing device such as a mouse, trackball, joystick, touchpad, or the like; a keyboard; a microphone with speech recognition interface; audio speakers; a display device; etc. Note, however, that such I/O devices may be unnecessary in a system that operates exclusively as a server and provides no direct user interface, as is the case with the server in at least some embodiments. Other variations upon the illustrated set of components can be implemented in a manner consistent with the invention.

Software and/or firmware 2730 to program the processor(s) 2710 to carry out actions described above may be stored in memory 2720. In certain embodiments, such software or firmware may be initially provided to the computer system 2701 by downloading it from a remote system through the computer system 2701 (e.g., via network adapter 2740).

The techniques introduced above can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic”, as used herein, can include, for example, programmable circuitry programmed with specific software and/or firmware, special-purpose hardwired circuitry, or a combination thereof.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

The teachings of the invention provided herein can be applied to other systems, not necessarily the system described above. The elements and acts of the various embodiments described above can be combined to provide further embodiments. While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

What is claimed is:

1. A method for determining a payment under a contract, the method comprising:
modeling, by a financial computing system, financial terms of the contract as a function of one or more first parameters, each of the one or more first parameters being a function of one or more second parameters, each of the one or more first or second parameters associated with one or more rules, wherein each rule represents terms of the contract as a set of a plurality of conditions and associated plurality of actions, each of the plurality of actions being performed when a corresponding plurality of conditions is satisfied;
forwarding, by the financial computing system, one or more rules to a contract rule-engine;
for each of the first or second parameters, interpreting, by the contract rule-engine, a relationship between the one or more rules associated with the given parameter;
receiving, by the financial computing system, details of a financial transaction governed by the contract;
identifying, by the financial computing system, one or more transaction conditions from the received details;
determining, by the financial computing system, a state value of the one or more transaction conditions based on the details of the financial transaction;
traversing, by the financial computing system, the interpreted relationship of each parameter based on the computed state value of the one or more transaction conditions to determine a transaction value for each of the plurality of parameters; and
determining, by the financial computing system, the payment under the financial terms of the contract as a function of the determined transaction values of the one or more first or second parameters.

2. The method of claim 1, wherein traversing the interpreted relationship of each of the plurality of parameters includes:
providing, by the financial computing system, the computed state value of each of the one or more transaction conditions to the rule-interpretation engine;
applying, by the contract rule-engine, the computed state value of each of the one or more transaction conditions to the rules associated with each of the parameters; and
determining, by the contract rule-engine, the transaction value for each of the parameters based on the outcome of each of the plurality of actions being performed when the plurality of conditions associated with each of the plurality of actions are evaluated based on the computed state value.

3. The method of claim 1, wherein the financial terms of a contract are determined by decomposing a contract into a plurality of contract templates, each contract template representing a predetermined plurality of financial terms.

4. The method of claim 1, wherein the contract is associated with a sale or purchase of electric power, further wherein the contract for sale or purchase of power includes one or more first or second parameters, the one or more first or second parameters including:
a committed rate; or
a committed load base rate.

5. The method of claim 1, wherein the contract is associated with a music license, further wherein the contract for music license includes one or more first or second parameters, the one or more first or second parameters including:
an effective royalty rate;
an effective unit;
an escalation rate;
a basic US rate;
a channel reduction rate; or
a territory reduction rate.

6. The method of claim 1, wherein the contract rule-engine includes one or more of:
a decision table; or
a rule engine.

7. The method of claim 6, wherein the rule engine is third-party software.

8. The method of claim 1, wherein said modeling financial terms of the contract as a function of one or more first or second parameters further includes:
incorporating changes to financial terms of the contract by adding to or removing from the one or more rules.

9. A method for determining a payment under a contract, the method comprising:
modeling, by a financial computing system, financial terms of the contract as a function of one or more parameters, each of the one or more parameters represented as a separate decision tree;
representing, by a financial computing system, each decision tree associated with the contract in a format suitable for computer implemented traversal;
receiving, by a financial computing system, details of a financial transaction governed by the contract;
traversing, by a financial computing system, each decision tree associated with each of the one or more parameters based on the received details of the financial transaction to determine a value for each of the one or more parameters; and
determining, by the financial computing system, the payment according to financial terms specified in the contract, the payment calculated as a function of the determined transaction values of the one or more parameters.

10. The method as recited in claim 9, wherein the modeling includes:
determining if contractual terms are for usages, rates, or modification factors; identifying contractual conditions; constructing decision tree branches based on identified contractual conditions; constructing leaf nodes; and filling in usages, rates or modification factors.

11. The method as recited in claim 9, wherein said modeling financial terms of the contract as a function of one or more first or second parameters further includes: providing a graphical user interface to enable a user to map information from the contract into a template; and automatically generating the decision tree representation via the mapped information that is used to model the financial terms of a contact.

12. The method as recited in claim 9, wherein the financial computing system uses Hadoop software for implementing a distributed file system.

13. The method as recited in claim 9, wherein the financial computing system uses a Map Reduce computing model for processing the financial transaction.

14. A method for modeling terms of a contract, the method comprising:
modeling, by a financial computing system, financial terms of the contract as a function of one or more first parameters, each of the one or more first parameters being a function of one or more second parameters, each of the one or more first or second parameters associated with one or more rules, wherein each rule represents terms of the contract as a set of a plurality of conditions and associated plurality of actions, each of the plurality of actions being performed when a corresponding plurality of conditions is satisfied.

15. The method of claim 14, wherein the financial terms of a contract are determined by decomposing a contract into a plurality of contract templates, each contract template representing a predetermined plurality of financial terms.

16. The method of claim 14, wherein said modeling financial terms of the contract as a function of one or more first or second parameters further includes:
incorporating changes to financial terms of the contract by adding to or removing from the one or more rules.

17. The method of claim 14, wherein for each of the first or second parameters, a contract rule-engine interprets the relationship between the one or more rules associated with the given parameter.

18. The method of claim 14, wherein the contract rule-engine includes one or more of;
a decision table; or
a rule engine.

19. The method of claim 14, wherein the contract is associated with a sale or purchase of electric power, further wherein the contract for sale or purchase of power includes one or more first or second parameters, the one or more first or second parameters including:
a committed rate; or
a committed load base rate.

20. The method of claim 14, wherein the contract is associated with a music license, further wherein the contract for music license includes one or more first or second parameters, the one or more first or second parameters including:
an effective royalty rate;
an effective unit;
an escalation rate;
a basic US rate;
a channel reduction rate; or
a territory reduction rate.

21. A financial computing system for determining a payment under a contra the system comprising;
a financial processing module for modeling financial terms of the contract as a function of one or more first parameters, each of the one or more first parameters being a function of one or more second parameters, each of the one or more first or second parameters associated with one or more rules, wherein each rule represents terms of the contract as a set of a plurality of conditions and associated plurality of actions, each of the plurality of actions being performed when a corresponding plurality of conditions is satisfied;
the financial processing module for forwarding one or more rules to a contract rule-engine;
for each of the first or second parameters, a contract rule-engine module for interpreting a relationship between the one or more rules associated with the given parameter;
the financial processing module for receiving details of a financial transaction governed by the contract;
the financial processing module for identifying one or more transaction conditions from the received details;
the financial processing module for determining a state value of the one or more transaction conditions based on the details of the financial transaction;
the financial processing module for traversing the interpreted relationship of each parameter based on the computed state value of the one or more transaction conditions to determine a transaction value for each of the plurality of parameters; and
the financial processing module for determining the payment under the financial terms of the contract as a function of the determined transaction values of the one or more first or second parameters.

22. The financial processing system as recited in claim 21, wherein the financial processing module for traversing the interpreted relationship of each of the plurality of parameters further comprises:
providing the computed state value of each of the one or more transaction conditions to the rule-interpretation engine;
applying the computed state value of each of the one or more transaction conditions to the rules associated with each of the parameters; and
determining the transaction value for each of the parameters based on the outcome of each of the plurality of actions being performed when the plurality of conditions associated with each of the plurality of actions are evaluated based on the computed state value.

23. The financial processing system as recited in claim 21, wherein the financial terms of a contract are determined by the financial processing module by decomposing a contract into a plurality of contract templates, each contract template representing a predetermined plurality of financial terms.

24. The financial processing system as recited in claim 21, wherein the contract modeled by the financial processing module is associated with a sale or purchase of electric power, further wherein the contract for sale or purchase of power includes one or more first or second parameters, the one or more first or second parameters including:
a committed rate; or
a committed load base rate.

25. The financial processing system as recited in claim 21, wherein the contract modeled by the financial processing module is associated with a music license, further wherein the contract for music license includes one or more first or second parameters, the one or more first or second parameters including:
an effective royalty rate;
an effective unit;
an escalation rate;
a basic US rate;
a channel reduction rate; or
a territory reduction rate.

26. The financial processing system as recited in claim 21, wherein the contract rule-engine module includes one or more of:
a decision table; or
a rule engine.

27. The financial processing system as recited in claim 26, wherein the rule engine included in the contract rule-engine module is third-party software.

28. The financial processing system as recited in claim 21, wherein said modeling financial terms of the contract by the financial processing module as a function of one or more first or second parameters further includes:
incorporating changes to financial terms of the contract by adding to or removing from the one or more rules.

29. A financial computing system for determining a payment under a contract, the system comprising:
a financial computing module for modeling financial terms of the contract as a function of one or more parameters, each of the one or more parameters represented as a separate decision tree;
the financial computing module for representing each decision tree associated with the contract in a format suitable for computer implemented traversal;
the financial computing module for receiving details of a financial transaction governed by the contract;
the financial computing module for traversing each decision tree associated with each of the one or more parameters based on the received details of the financial transaction to determine a value for each of the one or more parameters; and
the financial computing module for determining the payment according to financial terms specified in the contract, the payment calculated as a function of the determined transaction values of the one or more parameters.

30. The financial processing system as recited in claim 29, wherein the modeling includes: determining if contractual terms are for usages, rates, or modification factors; identifying contractual conditions; constructing decision tree branches based on identified contractual conditions; constructing leaf nodes; and filling in usages, rates or modification factors.

31. The financial processing system as recited in claim 29, wherein said modeling financial terms of the contract by the financial computing module as a function of one or more first or second parameters further includes: providing a graphical user interface to enable a user to map information from the contract into a template; and automatically generating the decision tree representation via the mapped information that is used to model the financial terms of a contact.

32. The financial processing system as recited in claim 29, wherein the financial computing module uses Hadoop software for implementing a distributed file system.

33. The financial processing system as recited in claim 29, wherein the financial computing module uses a Map Reduce computing model for processing the financial transaction.

34. A financial computing system for determining a payment under a contract, the system comprising:
a financial computing module for modeling financial terms of the contract as a function of one or more first parameters, each of the one or more first parameters being a function of one or more second parameters, each of the one or more first or second parameters associated with one or more rules, wherein each rule represents terms of the contract as a set of a plurality of conditions and associated plurality of actions, each of the plurality of actions being performed when a corresponding plurality of conditions is satisfied.

35. The financial processing system as recited in claim 34, wherein the financial terms of a contract are determined by the financial processing module by decomposing a contract into a plurality of contract templates, each contract template representing a predetermined plurality of financial terms.

36. The financial processing system as recited in claim 34, wherein said modeling financial terms of the contract by the financial processing module as a function of one or more first or second parameters further includes:
incorporating changes to financial terms of the contract by adding to or removing from the one or more rules.

37. The financial processing system as recited in claim 34, wherein for each of the first or second parameters, a contract rule-engine module interprets the relationship between the one or more rules associated with the given parameter.

38. The financial processing system as recited in claim 37, wherein the contract rule-engine module includes one or more of:
a decision table; or
a rule engine.

39. The financial processing system as recited in claim 34, wherein the contract modeled by the financial processing module is associated with a sale or purchase of electric power, further wherein the contract for sale or purchase of power includes one or more first or second parameters, the one or more first or second parameters including:
a committed rate; or
a committed load base rate.

40. The financial processing system as recited in claim 34, wherein the contract modeled by the financial processing module is associated with a music license, further wherein the contract for music license includes one or more first or second parameters, the one or more first or second parameters including:
an effective royalty rate;
an effective unit;
an escalation rate;
a basic US rate;
a channel reduction rate; or
a territory reduction rate.
